(19) United States
(12) Patent Application Publication
(10) Pub. No.: US 2008/0058062 A1
(43) Pub. Date: Mar. 6, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/638,466

(22) Filed: Dec. 14, 2006

Related U.S. Application Data
(60) Provisional application No. 60/842,028, filed on Sep. 5, 2006.

(51) Int. Cl. A63F 13/00

(52) U.S. Cl. 463/20

(57) ABSTRACT

In a slot machine, if the number of times of occurrence of a predetermined award reaches a predetermined number of times, a special game is executed for a predetermined number of times. During the special game, a controller accepts, after respective symbols are rearranged on the display, an external input requesting to shift the positions of the rearranged symbols. The controller shifts the positions of at least two or more symbols among those which have already been rearranged.

### CROSS-REFERENCE TO RELATED APPLICATION

This application is based upon and claims the benefit of U.S. Provisional Patent Application Ser. No. 60/842,028, filed on Sep. 5, 2006; the entire contents of which are incorporated herein by reference for all purposes.

### BACKGROUND OF THE INVENTION

1. Field of the Invention

The present invention relates to a slot machine for executing games using game media such as coins and bills, and a playing method thereof.

2. Description of Related Art

Conventional slot machines such as those disclosed in U.S. Pat. No. 6,604,999B2 are known, which make payouts in response to rearrangement of a winning combination along a payline of a display, or rearrangement of predetermined symbols on the display, in numbers equal to or more than a predetermined number.

In addition, U.S. Pat. No. 6,093,102A discloses a slot machine that makes a payout when a winning combination has been rearranged along a payline which allows addition of patterns based on the player' choice.

Since these slot machines determine the positions of the symbols to be rearranged on the display uniquely inside the slot machines, advent of a slot machine having a new taste of entertainment is expected.

### SUMMARY OF THE INVENTION

The slot machine according to a first aspect of the present invention comprises a display and a controller. A plurality of symbols that have been arranged are rearranged on the display in a unit game. The controller is operable to execute a predetermined number of times of the following unit game as a special game, whenever the number of times of occurrence of a predetermined award accompanied by payout of credits during the unit games reaches a predetermined number of times. And, during the special game, the controller is operable to accept an external input requesting to shift the positions of the symbols which have already been rearranged on the display and shift the positions of at least two or more symbols among those which have already been rearranged.

The slot machine according to a second aspect of the present invention comprises a display and a controller. A plurality of symbols that have been arranged are rearranged on the display in a unit game. The controller is operable to execute a predetermined number of times of the following unit game as a special game, whenever the number of times of occurrence of a predetermined award accompanied by payout of credits during the unit games reaches a predetermined number of times. And, during the special game, the controller is operable to accept an external input requesting to shift the positions of the symbols which have already been rearranged on the display before rearranging some of the symbols and shift the positions of at least two or more symbols among those which have already been rearranged before rearranging the some of the symbols.

The slot machine according to a third aspect of the present invention comprises a display and a controller. A plurality of symbols that have been arranged are rearranged on the display in a unit game. The controller is operable to execute a predetermined number of times of the following unit game as a special game, whenever the number of times of occurrence of a predetermined award accompanied by payout of credits during the unit games reaches a predetermined number of times. And, during the special game, the controller is operable to accept an external input requesting to shift the positions of the symbols which have already been rearranged on the display before rearranging some of the symbols and until elapse of a predetermined time period since the rearrangement of the symbols which have already been rearranged and shift the positions of at least two or more symbols among those which have already been rearranged before rearranging the some of the symbols. Further, the controller is operable to reject acceptance of the external input after a predetermined time period elapsed since the rearrangement of the symbols which have already been rearranged.

With the playing method of the slot machine according to a fourth aspect of the present invention, a unit game for rearranging a plurality of symbols which have been arranged on a display is executed. A predetermined number of times of the following unit game is executed as a special game, whenever the number of times of occurrence of a predetermined award accompanied by payout of credits during the unit games reaches a predetermined number of times. During the special game, an external input requesting to shift the positions of the symbols which have already been rearranged on the display is accepted, and the positions of at least two or more symbols among those which have already been rearranged are shifted.

With the playing method of the slot machine according to a fifth aspect of the present invention, a unit game for rearranging a plurality of symbols which have been arranged on a display is executed. A predetermined number of times of the following unit game is executed as a special game, whenever the number of times of occurrence of a predetermined award accompanied by payout of credits during the unit games reaches a predetermined number of times. During the special game, an external input requesting to shift the positions of the symbols which have already been rearranged on the display is accepted before rearranging some of the symbols, and the positions of at least two or more symbols among those which have already been rearranged are shifted before rearranging the some of the symbols.

With the playing method of the slot machine according to a sixth aspect of the present invention, a unit game for rearranging a plurality of symbols which have been arranged on a display is executed. A predetermined number of times of the following unit game is executed as a special game, whenever the number of times of occurrence of a predetermined award accompanied by payout of credits during the unit games reaches a predetermined number of times. During the special game, an external input requesting to shift the positions of the symbols which have already been rearranged on the display is accepted before rearranging some of the symbols and until elapse of a predetermined time period since the rearrangement of the symbols which have already been rearranged, and the positions of at least two or more symbols among those which have already been rearranged are shifted before rearranging the some of the symbols. Further, acceptance of the external input is rejected after a predetermined time period elapsed since the rearrangement of the symbols which have already been rearranged.

### BRIEF DESCRIPTION OF THE DRAWINGS

FIG. 1 is a flow chart schematically illustrating the playing method of the slot machine according to the present invention.

FIG. 2 is a perspective view showing the appearance of the slot machine according to an embodiment of the present invention.

FIG. 3 is a diagram illustrating the symbols to be displayed on respective display areas of the slot machine and code numbers of respective symbols, according to an embodiment of the present invention.

FIG. 4 is a diagram illustrating a payout table defining the relation between a combination for which payout is made and the payout amount, applied to the slot machine according to an embodiment of the present invention.

FIG. 5 is block diagram showing the control circuit of the slot machine according to an embodiment of the present invention.

FIG. 6 is a flow chart illustrating the procedure of authentication read processing of the game program and the game system program by the motherboard and the gaming board of the slot machine according to an embodiment of the present invention.

FIG. 7 is a flow chart illustrating a part of the processing procedure executed by the slot machine according to the first and second embodiments of the present invention.

FIG. 8 is a flow chart illustrating a part of the processing procedure of the base game executed by the slot machine according to an embodiment of the present invention.

FIG. 9 is a flow chart illustrating a part of the processing procedure of the base game executed by the slot machine according to an embodiment of the present invention.

FIG. 10 is a flow chart illustrating another part of the processing procedure of the base game executed by the slot machine according to an embodiment of the present invention.

FIG. 11 is a flow chart illustrating another part of the processing procedure of the base game executed by the slot machine according to an embodiment of the present invention.

FIG. 12 is a flow chart illustrating the procedure of stop-symbol determination processing executed by the slot machine according to an embodiment of the present invention.

FIG. 13 is a flow chart illustrating the procedure of symbol scroll control processing executed by the slot machine according to an embodiment of the present invention.

FIG. 14 is a flow chart illustrating the processing procedure of the bonus game executed by the slot machine according to an embodiment of the present invention.

FIG. 15 is a flow chart illustrating the procedure of symbol scroll processing executed by the slot machine according to an embodiment of the present invention.

FIG. 16 is a flow chart illustrating the processing procedure of the special game executed by the slot machine according to the second embodiment of the present invention.

FIG. 17A is a diagram illustrating an exemplary display when prompting to shift the symbols which are stopped in the base game.

FIG. 17B is a diagram illustrating an exemplary display when the player selected an area for shifting the symbols.

FIG. 17C is a diagram illustrating an exemplary display when the symbols are shifted.

FIG. 18A is a diagram illustrating an exemplary display when the symbols on the first and second columns are stopped in the base game.

FIG. 18B is a diagram illustrating an exemplary display when prompting to shifting the symbols which are stopped on the first and second columns.

FIG. 18C is a diagram illustrating an exemplary display when a player selected an area for shifting the symbols.

FIG. 18D is a diagram illustrating an exemplary display when the symbols are shifted.

FIG. 19A is a diagram illustrating an exemplary display when a winning combination of the symbols of “APPLEs” which triggers the bonus game is rearranged along a payline.

FIG. 19B is a diagram illustrating an exemplary display when a winning combination of “CHERRYs” relating to the starting condition of the special game is rearranged along a payline.

FIG. 20 illustrates a 5-column×5-row matrix of display areas of the slot machine according to an embodiment of the present invention.

FIG. 21 illustrates a payline provided on the slot machine according to an embodiment of the present invention.

### DETAILED DESCRIPTION OF THE EMBODIMENT

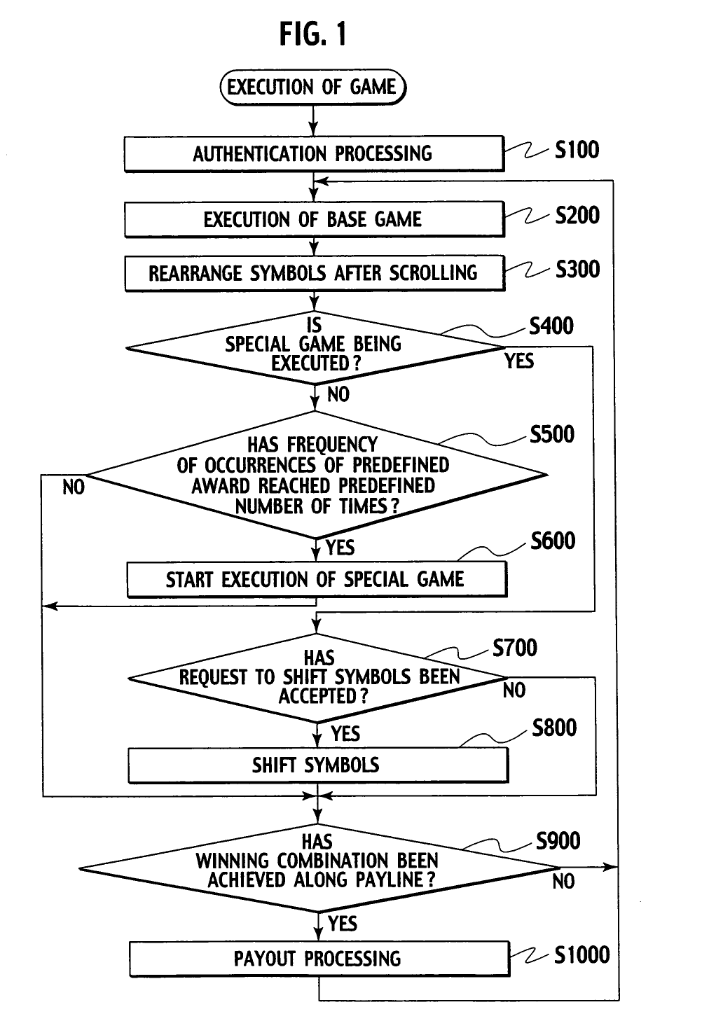

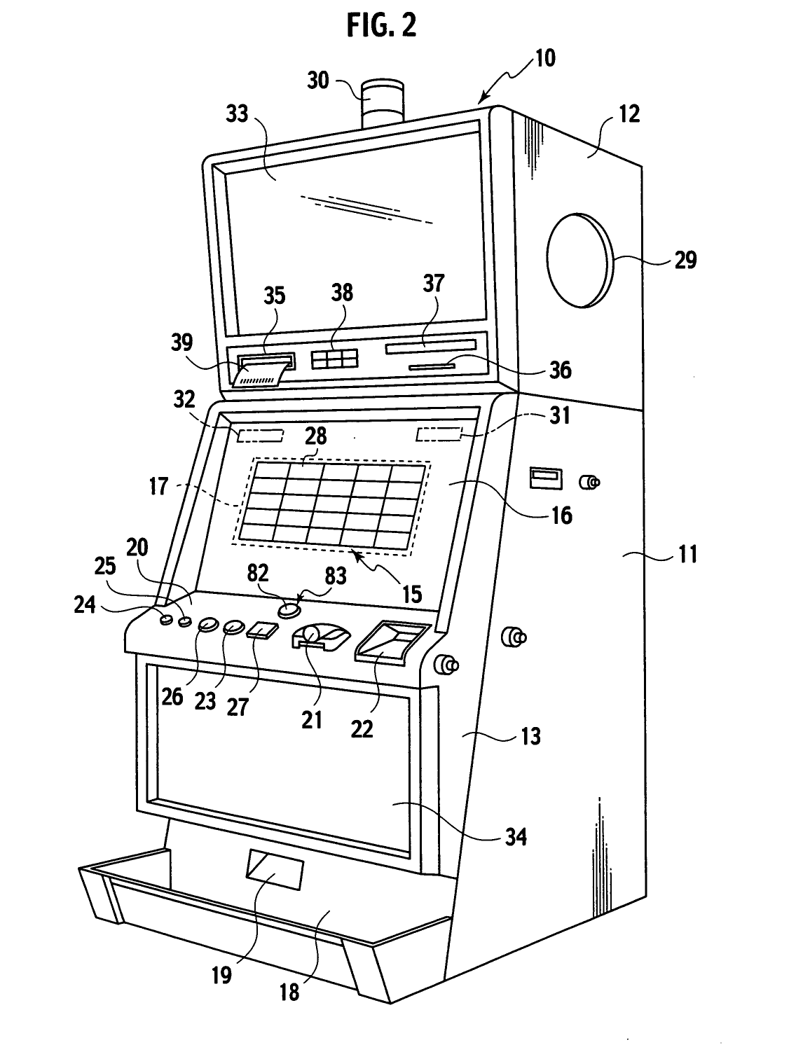

FIG. 1 is a flow chart schematically illustrating the playing method of the slot machine according to the present invention. The general operation of the slot machine and the playing method according to the present invention will be described below, referring to the flow chart shown in FIG. 1 and the perspective view shown in FIG. 2.

When powered on, the slot machine according to the present invention starts up and first executes an authentication processing (step S100). In this authentication processing, an initial checking processing is executed, prior to starting the unit game (base game, second game, or the like) in order to determine whether or not the program for operating the system normally operates, whether or not the program has been falsified, and so on.

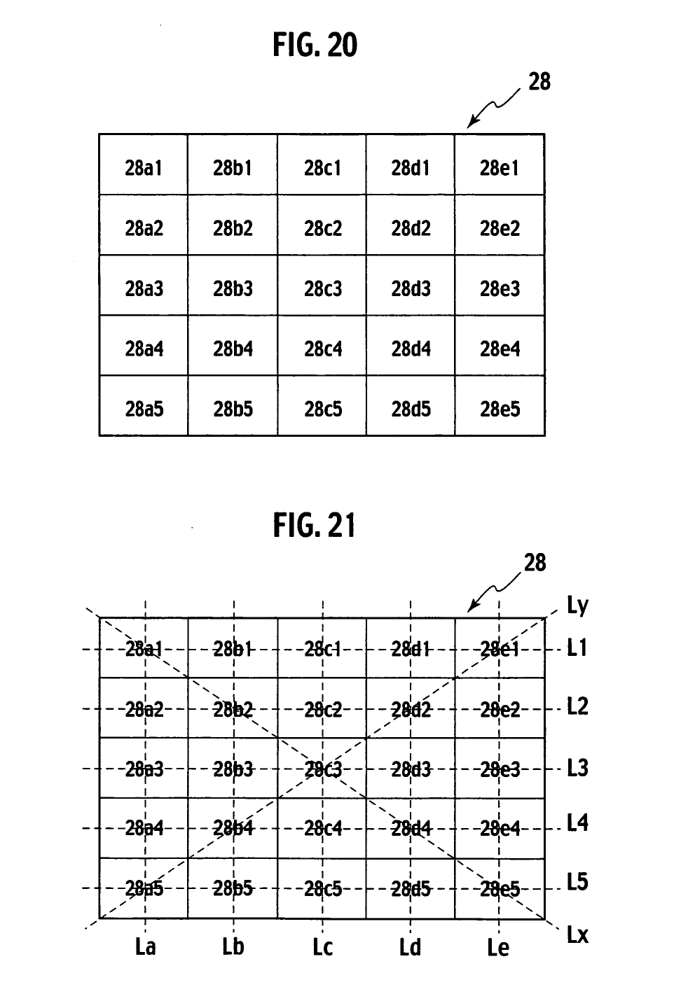

Next, the slot machine according to the present invention executes the base game (step S200). On the lower display panel 16 of the cabinet 11 is provided a display window 15. Symbols are displayed (arranged), respectively, on each of the 5-column×5-row, i.e., a total of 25 display areas 28 (28a1-28e5) of a liquid crystal display unit 17 inside the display window 15. Here, suffixes “a-e” of the number “28” of the display area 28 denote the columns and suffixes “1-5” denote the rows (see FIG. 20).

The base game is executed with the player's operation of pressing the spin button 23 being the trigger, under a condition that a desired number of credits have been bet by the player's operation of inserting coins into the coin insertion slot 21.

Then, during the base game, the slot machine according to the present invention scrolls the symbols displayed on respective display areas 28 (28a1-28e5) of the liquid crystal display unit 17, and subsequently stops (rearrange) the symbols on respective display areas 28 (step S300).

The slot machine according to the present invention now determines whether or not the special game is being executed, which is supposed to be executed for a predetermined number of times (step S400).

If the special game is not being executed (NO in step S400), the slot machine according to the present invention determines whether or not the number of times of occurrence of a predetermined award accompanied by payout of credits has reached a predetermined number of times (step S500). If the number of times of occurrence of the predetermined award has reached a predetermined number of times (YES in step S500), execution of the special game starts, which is supposed to be executed for a predetermined number of times (step S600).

If, otherwise, the special game is not being executed (No in step S400), the slot machine according to the present invention determines whether or not a winning combination accompanied by a payout is achieved along any of the paylines activated according to the number of credits which have been bet, among the paylines shown in FIG. 21 (five columns of vertical paylines La-Le, five rows of horizontal paylines L1-L5, and two paylines Lx and Ly running diagonally across the display areas 28), regardless of whether or not the number of times of occurrence of the predetermined award has reached a predetermined number of times (step S900).

On the other hand, if the special game is being executed (YES in step S400), the slot machine according to the present invention determines whether or not an external input requesting to shift the positions of the symbols which are stopped on respective display areas 28 has been accepted (step S700).

If an external input has been accepted (YES in step S700), the slot machine according to the present invention shifts the positions of at least two or more symbols which are stopped on respective display areas 28, according to accepted external input (step S800).

Then, if the special game is already being executed (YES in step S400), the slot machine according to the present invention also determines whether or not a winning combination accompanied by a payout is achieved along any of the paylines activated according to the number of credits which have been bet, among the paylines (five columns of vertical paylines La-Le, five rows of horizontal paylines L1-L5, and two paylines Lx and Ly running diagonally across the display areas 28), regardless of whether or not an external input requesting to shift the positions of the symbols has been accepted (step S900).

If a winning combination accompanied by a payout is achieved along the activated payline (YES in step S900), the slot machine according to the present invention executes payout to the winning combination (step S1000). Subsequently, a series of base games are completed and the process flow returns to step S200 and executes the base game.

Therefore, the slot machine according to the present invention shifts the positions of symbols in accordance with the external input requesting to shift the positions of at least two or more symbols which are stopped on respective display areas 28, when the number of times of occurrence of an award accompanied by payout of credits in the base game reaches a predetermined number of times and the special game which is supposed to be executed for a predetermined number of times is started. Interchanging the positions of the symbols increases the possibility of the winning combination accompanied by a payout to be achieved along any of the paylines (five columns of vertical paylines La-Le, five rows of horizontal paylines L1-L5, and two paylines Lx and Ly running diagonally across the display areas 28).

As thus described, with the slot machine according to the present invention, there is a case such that even if the symbols rearranged on respective display areas 28 are not laid out on positions that form a winning combination, they may be newly laid out in a position achieving the winning combination by shifting the positions of at least two or more symbols according to the external input.

The player can be thus provided with expectation that an award accompanied by payout of credits may occur, thereby stirring up the player's interest in the game.

Here, in the above example, the symbols are arranged on the 5-column×5-row display areas 28 (28a1-28e5). However, with the present invention, the display area 28 is not limited to five columns and five rows.

Additionally, in the above example, the paylines La-Le, L1-L5, Lx and Ly are provided linearly in vertical and horizontal directions (directions of the columns and rows), and in a diagonal direction across respective display areas 28. However, the paylines may be provided on respective display areas 28 in a V-shaped or inverted V-shaped arrangement.

Furthermore, in the above example, symbols are scrolled vertically on the display area 28 (28a1-28e5) and subsequently stopped (rearranged). However, the symbols may be switched over (rearranged) on respective display areas 28 (28a1-28e5).

Next, an arrangement of the slot machine 10 according to a first embodiment of the present invention will be explained referring to the perspective view shown in FIG. 2. The slot machine 10 is installed in a gaming facility.

The slot machine 10 uses coins, bills or electronic value information corresponding thereto as game media for executing the base game (unit game). However, with the present invention, game media are not limited in particular and medals, tokens, digital money, tickets or the like may be used, for example. Here, the above-mentioned tickets are not limited in particular, and bar-coded tickets described below may be used.

As shown in FIG. 2, the slot machine 10 comprises a cabinet 11, a top box 12 provided on top of the cabinet 11 and a main door 13 provided on the front face of the cabinet 11.

Inside the cabinet 11, a liquid crystal display unit 17 for scrolling a plurality of symbols is provided under a display window 15 made of transparent material. The liquid crystal display unit (display) 17 is composed of display areas 28 (see 28a1-28e5 of FIG. 20) for displaying a 5-column×5-row matrix of symbols. In other words, the symbols are scrolled on each of the 5-column×5-row display areas 28 (28a1-28e5) when the base game is executed. The player can view the scrolled symbols through the display windows 15 (15a-15e).

Then, in the present embodiment, each of the symbols displayed on each of the 5-column×5-row display areas 28 (28a1-28e5) is stopped when the base game is executed.

Here, although the 5-column×5-row display areas 28 (28a1-28e5) of the liquid crystal display unit 17 are given as an example in the present embodiment, the display areas 28 are not limited to a 5-column×5-row matrix.

A lower display panel 16 is provided in front of the liquid crystal display unit 17 on the main door 13. The lower display panel 16 has a transmissive liquid crystal panel, which displays various game-related information or effect images during the game.

A credit number display unit 31 and a payout number display unit 32 are provided on the lower display panel 16. The number of coins credited is displayed as an image on the credit number display unit 31. When a winning combination accompanied by a payout is achieved, the number of coins to be paid out is displayed as an image on the payout number display unit 32.

A winning combination is a combination of identical symbols, which are stopped along any of the paylines activated according to the number of credits which have been bet, among the paylines provided as shown in FIG. 21 (five columns of vertical paylines La-Le, five rows of horizontal paylines L1-L5, and two paylines Lx and Ly running diagonally across the display areas 28). If such a winning combination has come to a stop across the display areas 28, a predetermined number of coins are paid out. In addition, the number of coins to be paid out increases as the number of bets increases. For example, if the number of coins to be paid out is five when the number of bets is one, ten coins will be paid out if the number of bets is two.

Here, the payline may be provided, for example, so as to run across five display windows 15 (15a-15e) diagonally (V-shaped or inverted V-shaped).

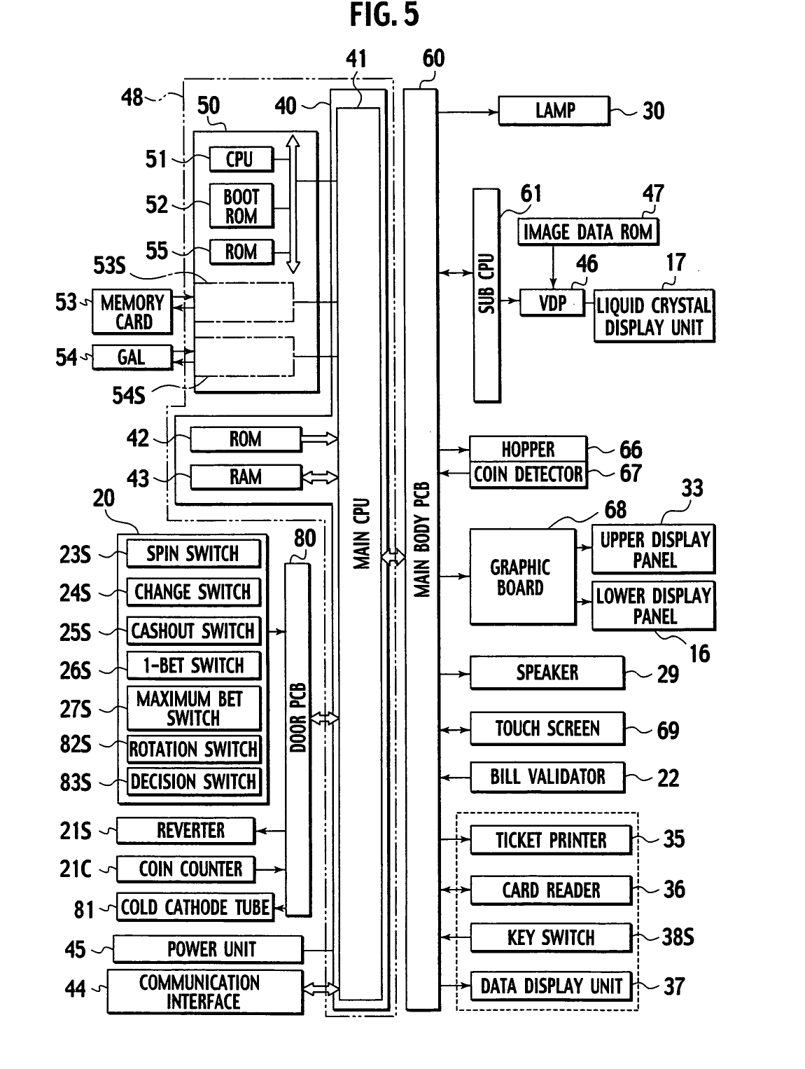

Furthermore, a touch screen 69 is provided on the front face of the lower display panel 16 (see FIG. 5). The player can input various instructions by operating the touch screen 69.

On the bottom of the lower display panel 16, a control panel 20 comprising a plurality of buttons 23-27 into which the player inputs the instructions relating to the progression of the game; a coin insertion slot 21 for accepting coins into the cabinet 11; and a bill validator 22 are provided.

Furthermore, a rotation button 82 and a decision button 83 are provided at the bottom of the lower display panel 16 to be operated by the player when shifting the positions of the symbols which have been stopped precedingly, on respective display areas 28a1-28b5 of the first and second columns among respective display areas 28 (28a1-28e5) of the 5-column×5-row matrix.

On the control panel 20 are provided a spin button 23, a change button 24, a cash out button 25, a 1-bet button 26 and a maximum bet button 27. The spin button 23 is a button for inputting an instruction to start scrolling of the symbols displayed on the display areas 28. The change button 24 is a button used when requesting money exchange to the clerk of the gaming facility. The cash out button 25 is a button for inputting an instruction to pay the coins which have been credited onto a coin tray 18.

The 1-bet button 26 is a button for inputting an instruction to bet one of the coins which have been credited on the game. The maximum bet button 27 is a button for inputting an instruction to bet, among the coins which have been credited on the game, a maximum number of coins (e.g., 50) which can be bet on a single game.

The bill validator 22 identifies whether or not the bill is authentic, and accepts legitimate bills into the cabinet 11. Here, the bill validator 22 may be configured so that it can read a bar-coded ticket 39 described below. A berry glass 34 having characters of the slot machine 10 drawn thereon is provided on the lower front face of the main door 13, i.e. at the bottom of the control panel 20.

An upper display panel 33 is provided on the front face of the top box 12. The upper display panel 33 comprises a liquid crystal panel. On the upper display panel 33, effect images, introduction of game contents, and rules of the games, for example, are displayed.

A speaker 29 for audio output is also provided on the top box 12. At the bottom of the upper display panel 33 are provided a ticket printer 35, a card reader 36, a data display unit 37, and a key pad 38. The ticket printer 35 prints bar codes on the ticket and outputs the ticket as the bar-coded ticket 39, where the bar codes are coded data such as number of credits, date and time, and identification number of the slot machine 10. The player can play games on other slot machines using the bar-coded ticket 39, or exchange the bar-coded ticket 39 with bills at the cashier of the gaming facility.

The card reader 36 reads and writes data from and to a smart card. The smart card is a card carried by the player, and stores data used for identifying the players or data relating to the gaming history by the player.

The data display unit 37 comprises a fluorescent display or the like, and displays the data read by the card reader 36 or the data entered by the player using the key pad 38, for example. Commands or data with regard to ticket publication are entered from the key pad 38.

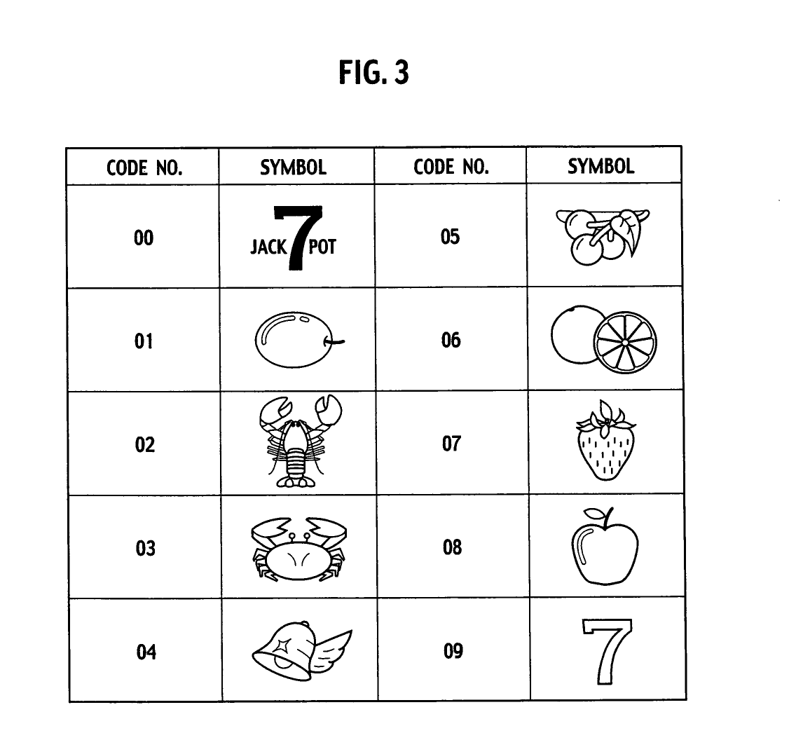

FIG. 3 is an explanatory drawing which shows the symbols to be scrolled on respective display areas 28 provided on the liquid crystal display unit 17 inside the cabinet 11. As shown in FIG. 3, a total of ten types of symbols composed of code numbers “00”-“09” are provided, and each of the symbols will be scrolled on respective display areas 28. Here, the symbols will be randomly scrolled regardless of the code number.

As symbols to be displayed on respective display areas 28 (28a1-28e5), “JACKPOT 7”, “PLUM”, “LOBSTER”, “CRAB”, “BELL”, “CHERRY”, “ORANGE”, “STRAWBERRY”, “APPLE” and “BLUE 7”, are provided. Then, a combination establishing an award accompanied by payout of credits is provided by combining these symbols.

Additionally, a payout table is provided in the slot machine 10 for determining the payout amount (payout rate) when a winning combination accompanied by a payout is achieved.

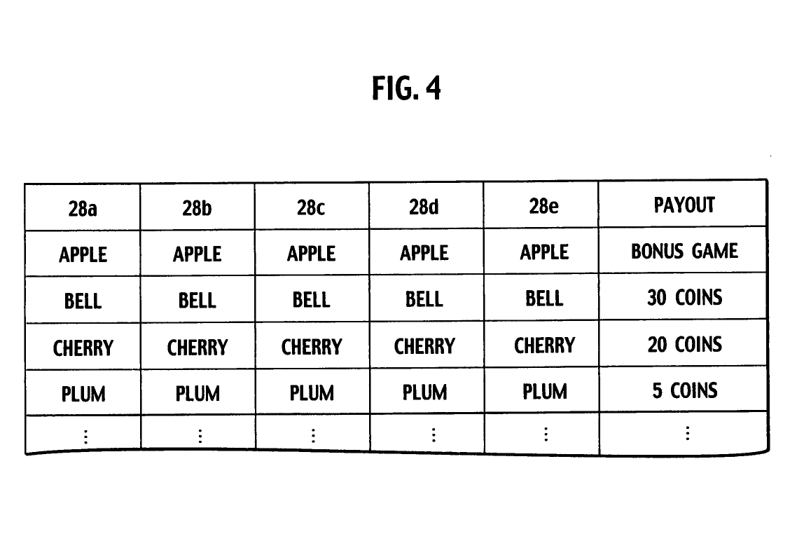

FIG. 4 is a diagram showing the above-mentioned payout table. According to this payout table, transition is made to the bonus game when five “APPLE” symbols align. In addition, 30 coins are paid out when five “BELL” symbols align, and 20 coins are paid out when five “CHERRY” symbols align.

The bonus game, which is executed when a combination of symbols of “APPLE” comes to a stop along the paylines La-Le, L1-L5, Lx and Ly, is a more advantageous gaming state than the base game. In the present embodiment, the bonus game is a free game (a game which can be played for a predetermined number of times without betting coins). In the present invention, the bonus game is not particularly limiting as long as it provides the player with an advantageous game state. Additionally, the bonus game which is advantageous for the player is not particularly limiting as long as it is more advantageous than the base game, such as, for example, a state in which more game media can be obtained than the base game, a state in which game media can be obtained with a higher probability than the base game, a state in which a smaller amount of game media is consumed than the base game. Specifically, the bonus game may include a free game, a second game, or the like.

Scrolling of the symbols which are displayed (arranged) on respective display areas 28 (28a-28e) starts by pressing the 1-bet button 26 or the maximum bet button 27 and subsequently pressing the spin button 23.

FIG. 5 is a block diagram illustrating a control circuit of the slot machine 10 shown in FIG. 2. As shown in FIG. 5, the control circuit comprises a motherboard 40, a main body PCB (Printed Circuit Board) 60, a gaming board 50, a sub CPU 61, a door PCB 80, and various types of switches or sensors. A controller 48 comprises the motherboard 40 and the gaming board 50.

The gaming board 50 comprises a CPU (Central Processing Unit) 51, a ROM 55 and a boot ROM 52 connected to each other by an internal bus, a card slot 53S for receiving a memory card 53, and an IC socket 54S for receiving a GAL (Generic Array Logic) 54.

The memory card 53 has gaming programs and gaming system programs recorded therein. The gaming programs include a stop-symbol determination program. The stop-symbol determination program is a program for determining the symbols (code numbers corresponding to the symbols) to be stopped along the paylines La-Le, L1-L5, Lx and Ly of respective display areas 28 (28a1-28e5). The stop-symbol determination program includes symbol weighting data corresponding to each of a plurality of payout rates (e.g., 80%, 84% or 88%). The symbol weighting data indicates the relation between the code numbers (see FIG. 3) of respective symbols and one or more random number values within a predetermined numerical range (0-256), respectively for each of the 5-column×5-row display areas 28 (28a-28e).

The payout rate is defined based on the payout rate setting data which is output from the GAL 54. The symbols to be stopped are determined, based on the symbol weighting data corresponding to the payout rate.

In addition, the card slot 53S, configured to be capable of inserting therein and removing therefrom the memory card 53, is connected to the motherboard 40 by the IDE bus. Thus, the type or content of the game to be executed on the slot machine 10 can be changed by removing the memory card 53 from the card slot 53S, writing other gaming programs and gaming system programs in the memory card 53, and inserting the memory card 53 into the card slot 53S.

The gaming programs include a program relating to the progress of the game and a program for shifting the state to the bonus game. In addition, the gaming programs include image data and sound data to be output during the game.

The GAL 54 comprises a plurality of input ports and output ports. When data is entered into the input port, data corresponding to the entered data is output from the output port. The data which is output from the output port is the above-mentioned payout rate setting data.

In addition, an IC socket 54S, configured to be capable of attaching thereto and removing therefrom the GAL 54, is connected to the motherboard 40 by the PCI bus. Thus, the payout rate setting data to be output from the GAL 54 can be changed by removing the GAL 54 from the IC socket 54S, rewriting the program to be stored in the GAL 54, and attaching the GAL 54 to the IC socket 54S.

The CPU 51, ROM 55 and boot ROM 52 connected to each other by an internal bus are connected to the motherboard 40 by PCI bus. The PCI bus communicates signals between the motherboard 40 and the gaming board 50, as well as supplying electric power from the motherboard 40 to the gaming board 50. The ROM 55 stores country identification information and an authentication program. The boot ROM 52 stores a preliminary authentication program and a program (boot code) by which the CPU 51 starts the preliminary authentication program.

The authentication program is a program for authenticating the gaming programs and the gaming system programs (falsification check program). The authentication program is a program for checking and proving that the gaming programs and the gaming system programs have not been falsified. In other words, the authentication program is written in accordance with the authenticating procedure of the gaming programs and the gaming system program. The preliminary authentication program is a program for authenticating the above-mentioned authentication program. The preliminary authentication program is written in accordance with the procedure of authenticating the authentication program, that is, to prove that the authentication program supposed to execute the authentication processing has not been falsified.

The motherboard 40 comprises a main CPU 41 (controller), a ROM (Read Only Memory) 42, a RAM (Random Access Memory) 43, and a communications interface 44.

The main CPU 41 is provided with functionality as a controller for controlling the entire slot machine 10. Particularly, when credits have been bet and the spin button 23 is pressed, the main CPU 41 executes controls of outputting a command signal to cause the sub CPU 61 to scroll the symbols on each of the display areas 28 (28a1-28e5) of the liquid crystal display unit 17, stop the symbols on the first and second columns of the display areas 28a1-28b5 precedingly, stop the symbols on the third to the fifth columns of the display areas 28c1-28e5 subsequently, and determining the payout amount using the payout table and making payout when the symbols composing a winning combination accompanied by a payout are stopped along the paylines La-Le, L1-L5, Lx and Ly.

In addition, after stopping the symbols on respective display areas 28a1-28b5 of the first and second columns, the main CPU 41 accepts the player's operation of the rotation button 82, the decision button 83 and the touch screen 69 for a constant time period before starting the control of stopping the symbols on the display areas 28c1-28e5 of the third to the fifth columns, and executes the control of shifting the positions of the symbols which are stopped on respective display areas 28a1-28b5 of the first and second columns.

The ROM 42 stores programs such as the BIOS (Basic Input/Output System) executed by the main CPU 41, as well as data to be used permanently. When the BIOS is executed by the main CPU 41, an initialization processing of each peripheral unit is executed and a read processing of the gaming programs and the gaming system programs stored in the memory card 53 is started via the gaming board 50.

The RAM 43 stores data and programs used by the main CPU 41 when executing the processes.

The communications interface 44 communicates, via a communication network, between the host computer or the like provided in the gaming facility.

In addition, a main body PCB (Printed Circuit Board) 60 and a door PCB 80, which will be described below, are connected to the motherboard 40 by a USB (Universal Serial Bus), respectively. Furthermore, a power unit 45 is connected to the motherboard 40. When electric power is supplied to the motherboard 40 from the power unit 45, the main CPU 41 of the motherboard 40 is activated, and electric power is supplied to the gaming board 50 via a PCI bus, thereby activating the CPU 51.

To the main body PCB 60 and the door PCB 80 are connected a device for generating an input signal which is fed to the main CPU 41 and a device whose operation is controlled by the control signal which is output from the main CPU 41. Based on the input signal, the main CPU 41 performs arithmetic processing by executing the game program and the game system program stored in the RAM 43, and stores the result in the RAM 43. In addition, main CPU 41 transmits control signals to respective devices to control the processing of respective devices.

To the main body PCB 60 are connected a sub CPU 61, a hopper 66, a coin detector 67, a graphic board 68, a speaker 29, a touch screen 69, a bill validator 22, a ticket printer 35, a card reader 36, a key switch 38S, and a data display unit 37.

The sub CPU 61 is connected to a VDP 46 (Video Display Processor) for executing the scrolling control the symbols on the five columns of display areas 28 (28a1-28e5) provided on the liquid crystal display unit 17.

The VDP 46 reads out the image data of symbols stored in the image data ROM 47, generates scroll images to be displayed on the liquid crystal display unit 17, and outputs the scroll images to the liquid crystal display unit 17.

The hopper 66 is provided inside the cabinet 11 and pays out a predetermined number of coins from the coin payout opening 19 to the coin tray 18 based on control signals output from the main CPU 41. The coin detector 67 is provided inside the coin payout opening 19 and outputs the input signal to the main CPU 41 if it is detected that a predetermined number of coins have been paid out from the coin payout opening 19.

The graphic board 68 controls display of images on the upper display panel 33 and the lower display panel 16 (except for displaying the symbols on the display areas 28), based on the control signals output from the main CPU 41.

The number of credits stored in the RAM 43 is displayed on the number-of-credits display unit 31 of the lower display panel 16. In addition, the number of coins paid out is displayed on the payout amount display unit 32 of the lower display panel 16. Additionally, the graphic board 68 comprises a VDP for generating image data based on control signals output from the main CPU 41 and a video RAM for temporarily storing the image data generated by the VDP.

The bill validator 22 reads the images of the bills and accepts legitimate bills into the cabinet 11. In addition, upon accepting a legitimate bill, the bill validator 22 outputs an input signal to the main CPU 41 according to the value of the bill. The main CPU 41 stores, in the RAM 43, the number of credits corresponding to the value of the bill, which has been transferred by the input signal.

The ticket printer 35 prints, based on control signals output from the main CPU 41, bar codes on the ticket and outputs the bar-coded ticket 39, the bar codes expressing coded data such as number of credits stored in the RAM 43, time and date, identification number of the slot machine 10 or the like.

The card reader 36 reads data from the smart card and transmits the data to the main CPU 41, or writes data into the smart card based on control signals from the main CPU 41. The key switch 38S is provided on the key pad 38 and outputs, when the key pad 38 is operated by the player, the input signal to the main CPU 41.

The data display unit 37 displays, based on the control signal output from the main CPU 41, the data read by the card reader 36 or the data entered by the player via the key pad 38.

A control panel 20, a revertor 21S, a coin counter 21C, and a cold cathode tube 81 are connected to the door PCB 80. On the control panel 20 are provided a spin switch 23S corresponding to the spin button 23, a change switch 24S corresponding to the change button 24, a cash out switch 25S corresponding to the cash out button 25, a 1-bet switch 26S corresponding to the 1-bet button 26, and a maximum bet switch 27S corresponding to the maximum bet button 27, a rotation switch 82S corresponding to the rotation button 82, and a decision switch 83S corresponding to the decision button 83. Respective switches 23S to 27S, 82S and 83S output, when their corresponding buttons 23 to 27, 82 and 83 are operated by the player, the input signals to the main CPU 41.

The coin counter 21C is provided inside the coin insertion slot 21 and discriminates whether or not the coin inserted into the coin insertion slot 21 by the player is legitimate. Coins other than legitimate ones are ejected from the coin payout opening 19. In addition, upon detecting a legitimate coin, the coin counter 21C outputs the input signal to the main CPU 41.

The revertor 21S operates based on control signals output from the main CPU 41 to distribute the coins recognized as legitimate coins by the coin counter 21C to either the cashbox (not shown) or the hopper 66 provided inside the slot machine 10. In other words, when the hopper 66 is filled with coins, legitimate coins are distributed to the cashbox by the revertor 21S. On the other hand, when the hopper 66 is not filled with coins, legitimate coins will be distributed to the hopper 66.

The cold cathode tube 81, which functions as a back light provided in the lower display panel 16 and the back side of the upper display panel 33, lights up based on control signals output from the main CPU 41.

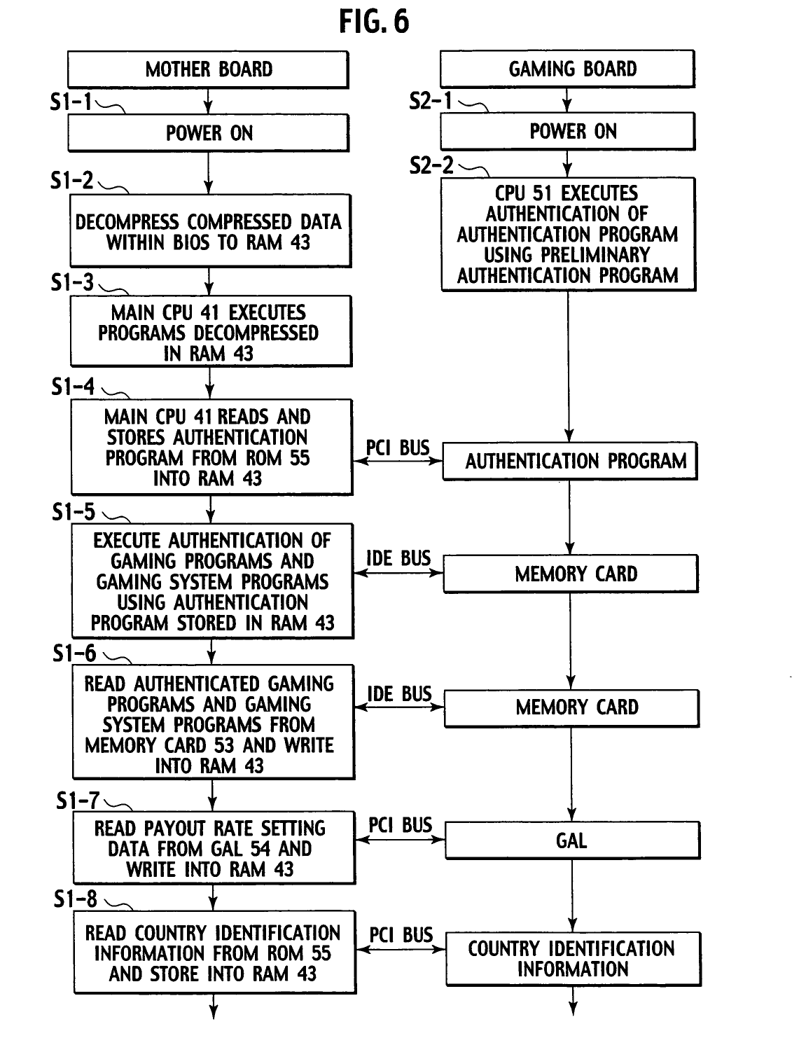

Next, a specific process which is executed in the slot machine 10 will be described. FIG. 6 is a flow chart illustrating the procedure (process of step S100 shown in FIG. 1) of the authentication read processing of the gaming programs and the gaming system program, executed by the motherboard 40 and the gaming board 50 shown in FIG. 5. Here, it is assumed that a memory card 53 is attached to the card slot 53S on the gaming board 50 and a GAL 54 is attached to the IC socket 54S.

First, upon switching on the power switch in the power unit 45, the motherboard 40 and the gaming board 50 are activated (steps S1-1 and S2-1). When the motherboard 40 and the gaming board 50 are activated, separate processes are executed in parallel. Specifically, in the gaming board 50, the CPU 51 reads out the preliminary authentication program stored in the boot ROM 52 and executes a preliminary authentication in accordance with the read-out preliminary authentication program to check and prove that the authentication program has not been falsified, before loading it into the motherboard 40 (step S2-2).

In the motherboard 40, on the other hand, the main CPU 41 executes the BIOS stored in the ROM 42 and decompresses the compressed data embedded in the BIOS to the RAM 43 (step S1-2). Then the main CPU 41 executes the BIOS which has been decompressed into the RAM 43 and executes diagnosis and initialization of various peripheral units (step S1-3).

Since the ROM 55 of the gaming board 50 is connected to the main CPU 41 via the PCI bus, the main CPU 41 then reads out the authentication program stored in the ROM 55. Furthermore, the main CPU 41 stores the read-out authentication program into the RAM 43 (step S1-4).

Next, the main CPU 41 accesses the memory card 53 attached to the card slot 53S via the IDE bus. Then, the main CPU 41 reads out the gaming programs and the gaming system programs stored in the memory card 53.

Next, the main CPU 41 checks and proves (authenticates), in accordance with the authentication program stored in the RAM 43, that the read-out gaming programs and the gaming system programs have not been falsified (step S1-5).

If the authentication processing is completed normally, the main CPU 41 stores the authenticated gaming programs and gaming system programs into the RAM 43 (step S1-6). Next, the main CPU 41 accesses the GAL 54 connected to the IC socket 54S via the PCI bus, and reads the payout rate setting data from the GAL 54 and stores it into the RAM 43 (step S1-7). Next, the main CPU 41 reads the country identification information stored in the ROM 55 of the gaming board 50 via the PCI bus, and stores it into the RAM 43 (step S1-8).

After executing the above-mentioned process, the main CPU 41 advances the base game as described below, by sequentially reading out and executing the gaming programs and the gaming system program.

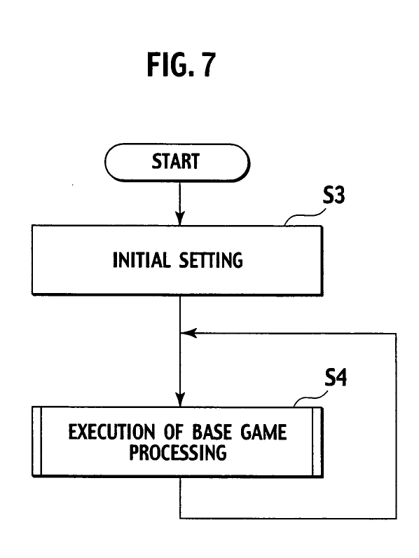

After the authentication read processing shown in FIG. 6 has been executed, the main CPU 41 executes an initial setting (step S3) and subsequently the base game processing (step S4) as shown in the flow chart of FIG. 7.

In the initial setting, the main CPU 41 sets the flag F of the RAM 43 which indicates whether or not the special game is being executed to “0”. In addition, the main CPU 41 resets the count value M of the achievement counter of the RAM 43 to 0, the value indicating the number of times a predetermined award has been achieved, which is the starting condition of the special game. Furthermore, the main CPU 41 resets the count value N of the execution counter of the RAM 43 to 0, the value indicating the number of times the special game has been executed.

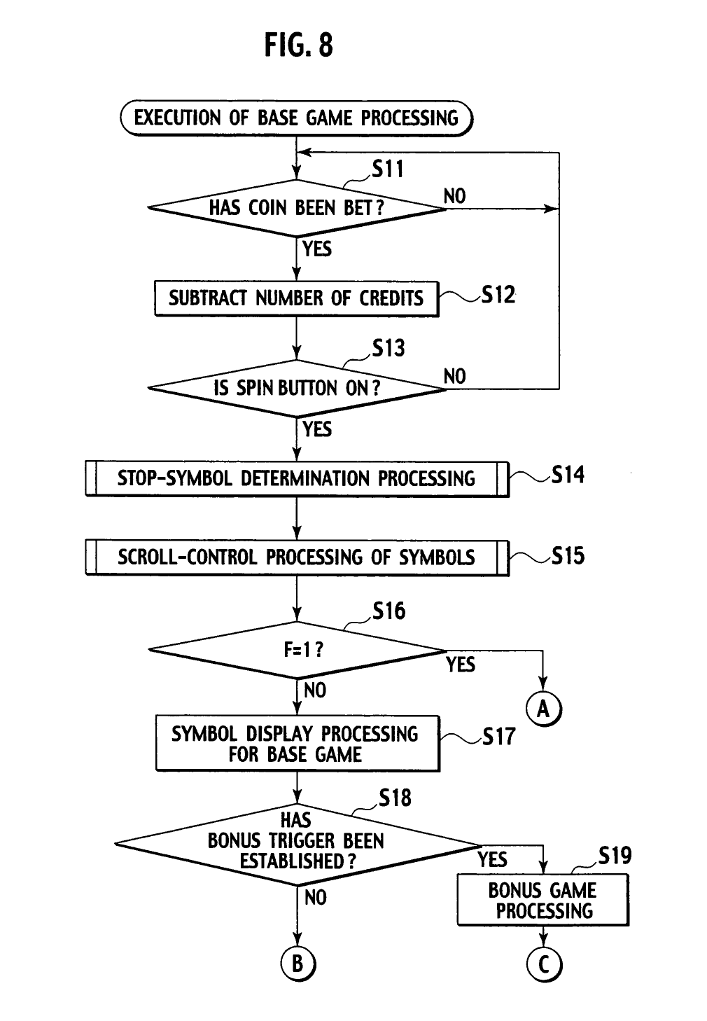

FIGS. 8-11 are flow charts illustrating a specific processing procedure of executing the base game, as shown in step S200 of FIG. 1 and step S4 of FIG. 7.

In the execution of the base game processing, the main CPU 41 first determines, as shown in FIG. 8, whether or not one or more coins have been bet (step S11). In this process, the main CPU 41 determines whether or not it has received an input signal which is output from the 1-bet switch 26S when the player presses the 1-bet button 26 or an input signal which is output from the maximumbet switch 27S when the player presses the maximum bet button 27. If it is determined that no coin has been bet by the player, the process flow returns to step S11.

On the other hand, it is determined that one or more coins have been bet by the player in step S11, the main CPU 41 subtracts the credit number stored in the RAM 43 according to the number of coins which have been bet (step S12). Here, if the number of coins which have been bet is larger than the credit number stored in the RAM 43, the main CPU 41 puts the process back to step S11 without subtracting the credit number stored in the RAM 43. In addition, if the number of coins bet exceeds an upper limit (50 in the present embodiment) which can be bet for a single game, the main CPU 41 advances the process to step S13 without subtracting the number of credits stored in the RAM 43. In this condition, the symbols become scrollable on the display areas 28 (28a1-28e5).

Next, the main CPU 41 determines whether or not the spin button 23 has been turned ON by the player (step S13). In this process, the main CPU 41 determines whether or not it has received an input signal which is output from the spin switch 23S when the player presses the spin button 23.

If it is determined that the spin button 23 has not been turned ON by the player, the main CPU 41 puts the process back to step S11. Here, if the spin button 23 has not been turned ON by the player (e.g., if an instruction to terminate the game is input without the spin button 23 having been turned ON by the player), the main CPU 41 cancels the result of subtraction in step S12.

In the present embodiment, a subtraction processing of the credit number is executed (step S12) after the player bet the coins (step S11) and before determining whether or not the player has turned ON the spin button 23 (step S13). However, the present invention is not limited to the above example. For example, determination of whether or not the spin button 23 has been turned ON (step S13) may be performed after the player bet the coins (step S11), and subtraction of the credit number (step S12) may be executed at the timing when it is determined that the spin button 23 has been turned ON by the player (YES in step S13).

Then, if it is determined that the spin button 23 has been turned ON by the player in step S13 of FIG. 8, the main CPU 41 executes the stop-symbol determination processing (step S14). In the stop-symbol determination processing, the main CPU 41 determines the symbols to be displayed through the display window 15 when the symbols come to a stop on respective display areas 28 (28a1-28e5), by executing the stop-symbol determination program stored in the RAM 43.

Next, the main CPU 41 executes a scroll control processing to scroll the symbols on respective display areas 28 (28a1-28e5) (step S15).

The stop-symbol determination processing and scroll control processing will be described in detail below.

The main CPU 41 then checks whether or not the flag F of the RAM 43 is “1”, which indicates that the special game is being executed (step S16).

IF the flag F is not “1”, i.e., if the special game is not being executed (No in step S16), the main CPU 41 executes the symbol display processing for the base game to display the stopped symbols on respective display areas 28a1-28e5 of the liquid crystal display unit 17 (step S17). Then the main CPU 41 determines whether or not a bonus trigger has been established based on the symbols on respective display areas 28a1-28e5 (step S18).

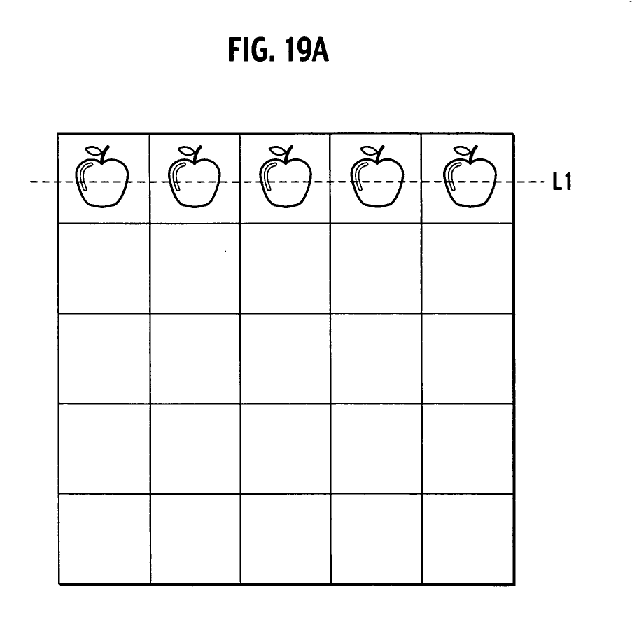

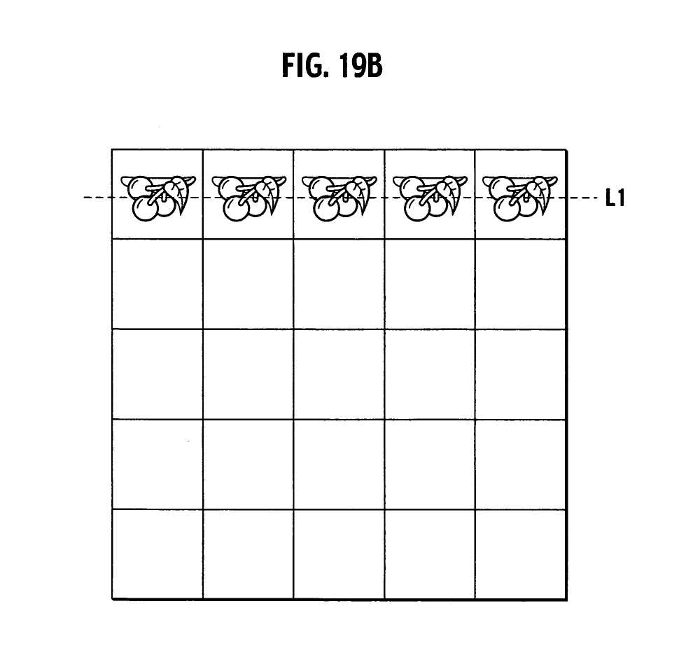

Whether or not the bonus trigger has been established is determined according to whether or not a combination of “APPLEs” as shown in FIG. 19A, for example, is achieved along the paylines La-Le, L1-L5, Lx and Ly (in FIG. 19A, payline L1) activated according to the number of credits which have been bet.

If it is determined that the bonus trigger has been established (YES in step S18), the bonus game processing described below is executed (step S19).

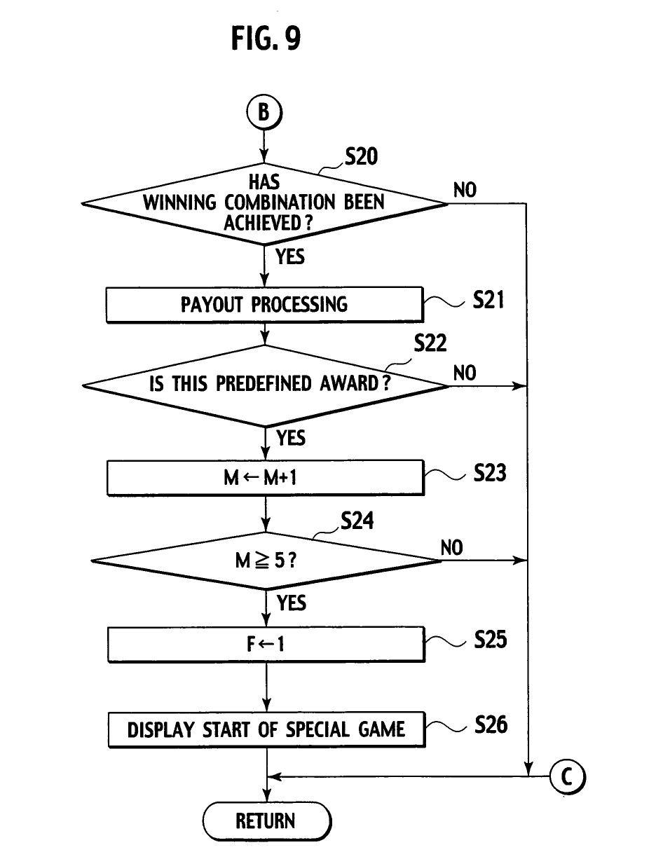

Otherwise, the bonus trigger has not been established (NO in step S18), the main CPU 41 determines whether or not a winning combination accompanied by a payout is achieved along the paylines La-Le, L1-L5, Lx and Ly activated by the symbols which have been stopped on respective display areas 28a1-28e5, as shown in FIG. 9 (step S20).

If a winning combination is achieved along the activated paylines La-Le by the symbols which have been stopped on respective display areas 28, L1-L5, Lx and Ly (YES in step S20), the main CPU 41 applies the payout rate (payout amount) defined in the payout table of FIG. 4, and executes the payout processing for the winning combination (step S21).

Subsequently, it is checked whether or not the achieved winning combination is a predetermined award, for example, whether or not the winning combination of “CHERRYs” along the activated payline(s) among the paylines La-Le, L1-L5, Lx and Ly (payline L1 in FIG. 19B) deserves an award (step S22).

If the achieved winning combination deserves a predetermined award (YES in step S22), the count value M of the achievement counter of the RAM 43 is incremented by “1” (step S23). Subsequently, it is determined whether or not the count value M of the achievement counter has reached a specific value (five in the present embodiment), i.e., whether or not the number of achievement times of the predetermined award reached a predetermined number of times (step S24).

If the count value M of the achievement counter reaches 5 (YES in step S24), the main CPU 41 sets the flag F of the RAM 43 to “1”, which indicates that the special game is being executed (step S25). In addition, the main CPU 41 displays a message superimposed on the symbols on respective display areas 28a1-28e5 of the liquid crystal display unit 17, notifying the start of the special game (step S26). Furthermore, the main CPU 41 terminates the execution of a series of base games, and transits to the next execution of the base game processing.

In addition, the execution of serial processing of base games is completed and the process flow transits to the next execution of the base game processing in any of the following cases: a winning combination has not been achieved along the activated payline(s) among the paylines La-Le, L1-L5, Lx and Ly (NO in step S20); the achieved winning combination is not a predetermined award (NO in step S22); or the count value M of the achievement counter has not reached 5 (NO in step S24).

On the other hand, if the flag F of the RAM 43 is “1”, i.e., if the special game is being executed (YES in step S16) in step S16 of FIG. 8, the main CPU 41 executes the symbol display processing for a special game (step S27).

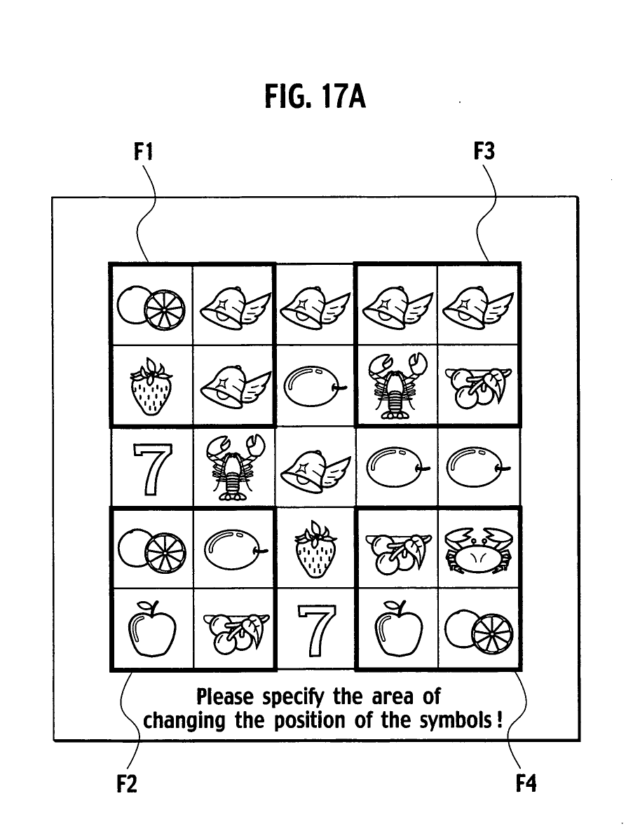

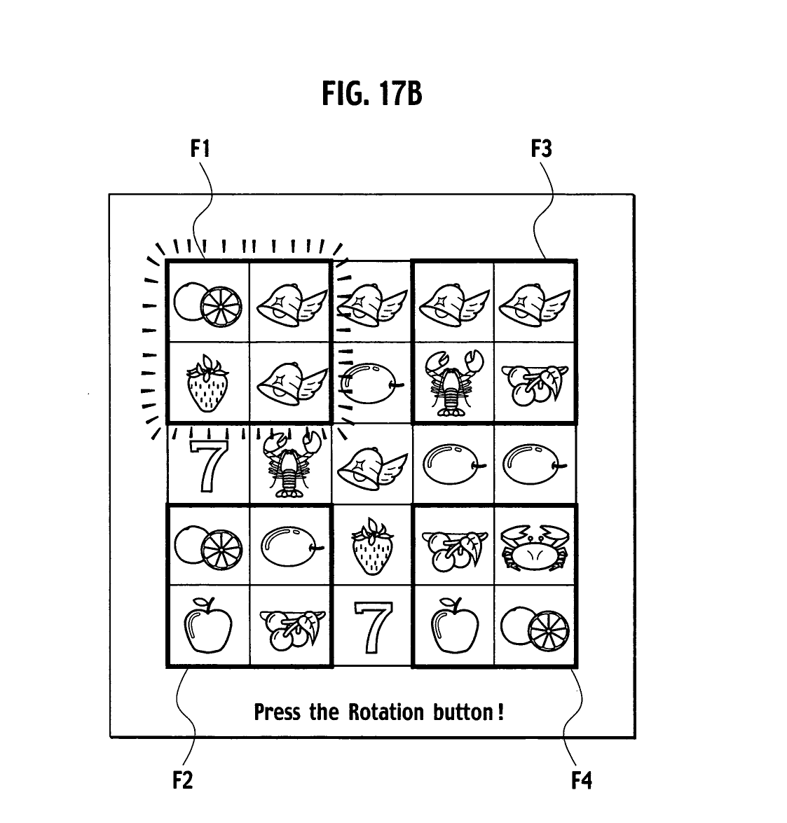

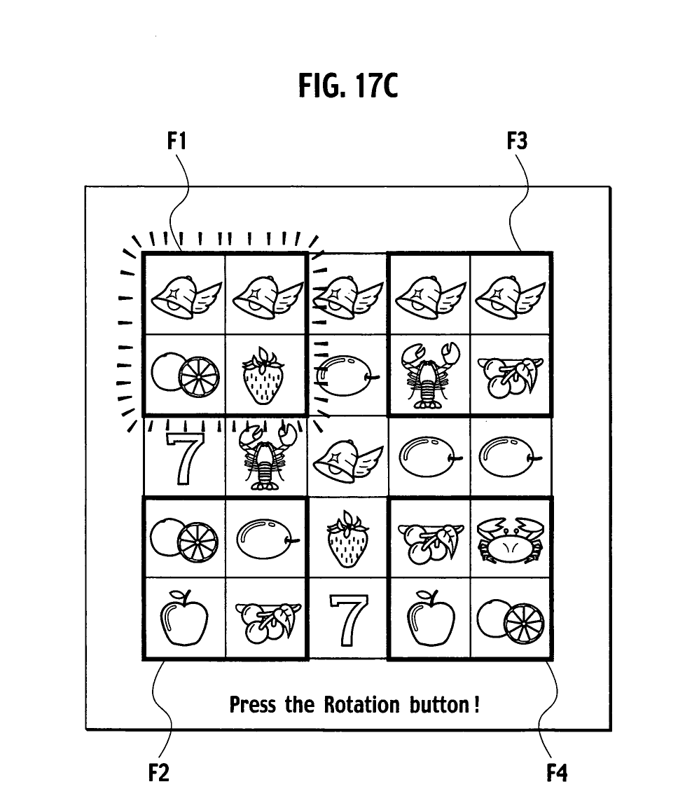

In the symbol display processing for the special game, the main CPU 41 first displays the stopped symbols on respective display areas 28a1-28e5 with a reduced size on the liquid crystal display unit 17, as shown in FIG. 17A.

In addition, the main CPU 41 displays, on the liquid crystal display unit 17, a frame F1 surrounding the upper four display areas 28a1, 28a2, 28b1 and 28b2 of the first and second columns, a frame F2 surrounding the lower four display areas 28a4, 28a5, 28b4 and 28b5 of the first and second columns, a frame F3 surrounding the upper four display areas 28d1, 28d2, 28e1 and 28e2 of the fourth and fifth columns, and a frame F4 surrounding the lower four display areas 28d4, 28d5, 28e4 and 28e5 of the fourth and fifth columns of respective display areas 28a1-28e5.

Furthermore, the main CPU 41 displays a message “Please specify the area of changing the position of the symbols!,” prompting to shift the positions of the symbols in respective frames F1-F4 in the margin on the periphery of the zoomed-out display areas 28 of the liquid crystal display unit 17.

Subsequent to the symbol display processing for the special game of step S18, the main CPU 41 checks whether or not the player has chosen to shift the positions of the symbols, i.e., whether or not a request to shift the positions of the symbols has been accepted (step S28).

Whether or not a request to shift the positions of the symbols has been accepted is checked via the touch screen 69 by detecting whether or not the player has touched any of the four display areas 28a1, 28a2, 28b1 and 28b2 surrounded by the frame F1, the four display areas 28a4, 28a5, 28b4 and 28b5 surrounded by the frame F2, the four display areas 28d1, 28d2, 28e1 and 28e2 surrounded by the frame F3, or the four display areas 28d4, 28d5, 28e4 and 28e5 surrounded by the frame F4.

If a request to shift the positions of the symbols has been accepted (YES in step S28), the main CPU 41 switches the display mode, on the liquid crystal display unit 17, of the frame F1 surrounding the display areas 28a1, 28a2, 28b1 and 28b2 (alternatively, the frames F2, F3 or F4) selected by the player's touching operation to an intermittent display as shown in FIG. 17B (step S29). In addition, the main CPU 41 displays a message “Press the Rotation button!” on the margin of the liquid crystal display unit 17, prompting the player to operate the rotation button 82 (step S29).

Note that, in the following description, the player is assumed to have selected the upper four display areas 28a1, 28a2, 28b1 and 28b2 of the first and second columns as a display area for shifting the positions of the symbols.

The main CPU 41 then determines whether or not an input signal accompanying the player's operation of the rotation button 82 has been received from the rotation switch 82S (step S30).

If the main CPU 41 has received an input signal from the rotation switch 82S (YES in step S30), it rotates counterclockwise the positions of respective symbols which are stopped on the display areas 28a1, 28a2, 28b1 and 28b2 selected by the player, according to the number of times the input signal has been received, as shown in FIG. 17C (step S31). In addition, the main CPU 41 determines whether or not an input signal accompanying the player's operation of the decision button 83 has been received from the decision switch 83S (step S32).

If the main CPU 41 has received an input signal from the decision switch 83S (YES in step S32), it switches the intermittent display mode of the frame F1 surrounding the display areas 28a1, 28a2, 28b1 and 28b2 back to the stationary display mode. In addition, the main CPU 41 displays a message “Please specify the area of changing the position of the symbols!” on the margin of the liquid crystal display unit 17 again, prompting for possible shifting of the positions of the symbols within respective frames F1-F4 (step S33).

Additionally, if the main CPU 41 has not accepted a request to shift the positions of the symbols (NO in step S28), has not received an input signal from the rotation switch 82S (NO in step S30), or has not received an input signal from the decision switch 83S (NO in step S32), it checks whether or not the elapsed time s since the symbols came to a stop on respective display areas 28a1-28e5 has reached a predetermined acceptance period S (step S34). The main CPU 41 still checks whether or not the elapsed time s has reached the acceptance period S (step S34), even after switching the intermittent display of the frame F1 back to the stationary display mode and displaying the message “Please specify the area of changing the position of the symbols!” on the margin of the liquid crystal display unit 17 again (step S33). If the elapsed time s has not reached the acceptance period S (NO in step S34), the main CPU 41 repeats the process of step S28 and subsequent steps.

On the other hand, if the elapsed time s has reached the acceptance period S (YES in step S34), the main CPU 41 stops displaying the frames F1-F4, the zoomed-out display of the symbols on the display areas 28a1-28e5, and displaying the message on the margin of the liquid crystal display unit 17. The main CPU 41 then displays the symbols on respective display areas 28a1-28e5 in a normal size and fixes the positions of the symbols (step S35).

Subsequently, the main CPU 41 determines whether or not a bonus trigger has been established by the symbols on respective display areas 28a1-28e5, as with step S18 of FIG. 8 (step S36). If it is determined that a bonus trigger has been established, the bonus game processing described below is executed (step S37).

If, otherwise, a bonus trigger has not been achieved (NO in step S36), the main CPU 41 determines, as with step S20 of FIG. 9, whether or not a winning combination is achieved by the symbols which have been stopped on respective display areas 28a1-28e5 (step S38).

If a winning combination is achieved by the symbols which have been stopped on respective display areas 28 (YES in step S38), the main CPU 41 applies a payout rate (payout amount) defined in the payout table of FIG. 4 and executes the payout processing for the winning combination (step S39).

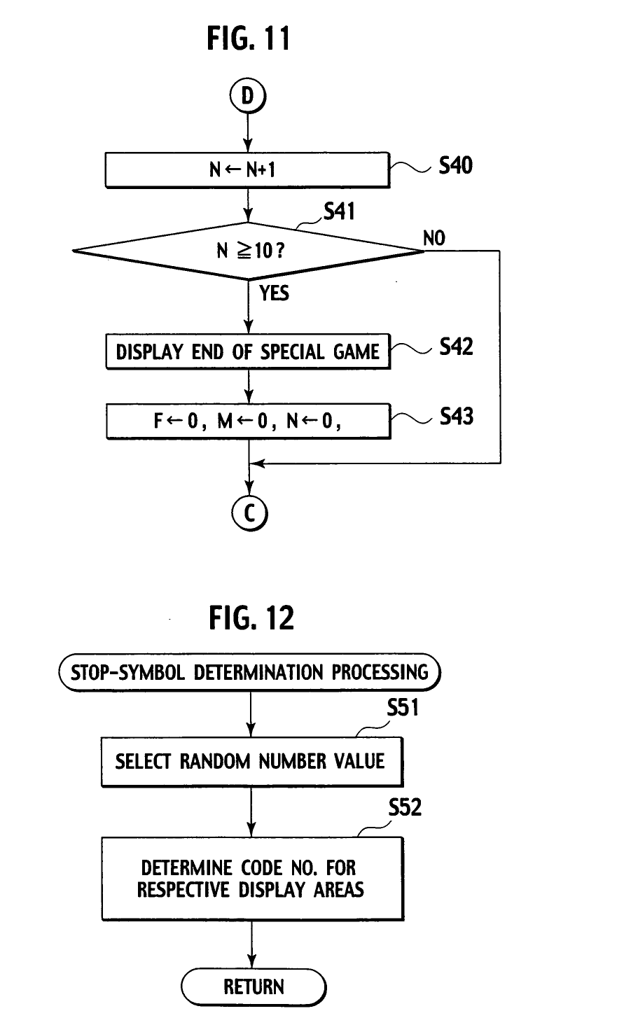

The main CPU 41 increments the count value N of the execution counter of the RAM 43 by “1” (step S40), indicating the number of times the special game has been executed as shown in FIG. 11, in all of the following occasions: after the execution of the bonus game processing (step S37); if no winning combination has been achieved (NO in step S38); or after the execution of payout processing for the achieved winning combination (step S39). Subsequently, the main CPU 41 checks whether or not the count value N of the execution counter has reached a predetermined value (10 in the present embodiment), i.e., whether or not the special game has been executed for a predetermined number of times (step S41).

When the count value N of the execution counter has reached 10 (YES in step S41), the main CPU 41 displays a message notifying the end of the special game, the message being superimposed on the symbols on respective display areas 28a1-28e5 of the liquid crystal display unit 17 (step S42).

The main CPU 41 then sets the flag F of the RAM 43 to “0”, indicating that the special game is not being executed, and resets the achievement count value M of the RAM 43 counter and the execution count value N of the execution counter to “0” (step S43). Subsequently, the main CPU 41 terminates the special game being concurrently executed with base game, and transits to an independent execution of the base game processing.

The base game and special game are executed in this manner.

Here, when saving the coins to be paid out, the main CPU 41 adds a predetermined number of credits to the credit number stored in the RAM 43. When, otherwise, paying out the coins, the main CPU 41 transmits a control signal to the hopper 66 to pay out a predetermined number of coins. In this occasion, the coin detector 67 counts the number of coins to be paid out from the hopper 66, and transmits a payment completion signal to the main CPU 41 when the count value reaches a specified number. Thus the main CPU 41 stops driving the hopper 66 and terminates the payout of the coins.

Therefore, with the slot machine 10 of the present embodiment, the special game is executed for a predetermined number of times if a predetermined award is achieved for a predetermined number of times (five in the present embodiment), where the award is such that a winning combination of “CHERRYs” has been achieved along the activated payline(s) among the paylines La-Le, L1-L5, Lx and Ly (payline L1 in FIG. 19B).

Here, the positions of the symbols can be shifted, even if identical symbols have not come to a stop along any of the activated payline(s) among the paylines La-Le, L1-L5, Lx and Ly when the symbols are stopped on respective display areas 28a1-28e5 during execution of the special game. This provides a possibility of stopping identical symbols along any of the activated paylines La-Le L1-L5, Lx and Ly.

In other words, it is possible to stop identical symbols along any of the activated payline(s) among the paylines La-Le, L1-L5, Lx and Ly by shifting, within the frames F1-F4, the positions of the symbols on the upper four display areas 28a1, 28a2, 28b1 and 28b2 of the first and second columns, the positions of the symbols on the lower four display areas 28a4, 28a5, 28b4 and 28b5 of the first and second columns, the symbol position on the upper four display areas 28d1, 28d2, 28e1, 28e2 of the fourth and fifth columns, and the positions of the symbols of the lower four display areas 28d4, 28d5, 28e4 and 28e5 of the fourth and fifth columns.

Accordingly, with the slot machine 10 of the present embodiment, the possibility that a winning combination can be stopped along the activated payline(s) among the paylines La-Le, L1-L5, Lx and Ly becomes higher than conventional slot machines.

Next, the stop-symbol determination processing shown in step S14 of FIG. 8 will be described referring to the flow chart shown in FIG. 12.

FIG. 12 is a flow chart illustrating the procedure of the stop-symbol determination processing shown in step S14 of FIG. 8. This process is performed by the main CPU 41 which executes the stop-symbol determination program stored in the RAM 43.

First, the main CPU 41 generates, from a numerical range of 0-255, random number values corresponding to each of respective display areas 28 (28a1-28e5) by executing a random number generation program included in the stop-symbol determination program (step S51).

Next, the main CPU 41 looks up the symbol weighting data that corresponding to the payout rate setting data which has been output from the GAL 54 and stored into the RAM 43. The main CPU 41 determines the code numbers (see FIG. 3) of respective display areas 28 (28a1-28e5), based on the selected five random number values (step S52).

The code numbers of respective display areas 28 (28a1-28e5) corresponds to the code numbers of the symbols displayed in a stopped state along the paylines La-Le, L1-L5, Lx and Ly. The main CPU 41 determines the winning combination by determining the code numbers of respective display areas 28. For example, if the code numbers of respective display areas 28 (28a1-28e5) are determined to be “00”, “00”, “00”, “00” and “00”, respectively, the main CPU 41 determines the winning combination to be “JACKPOT 7”.

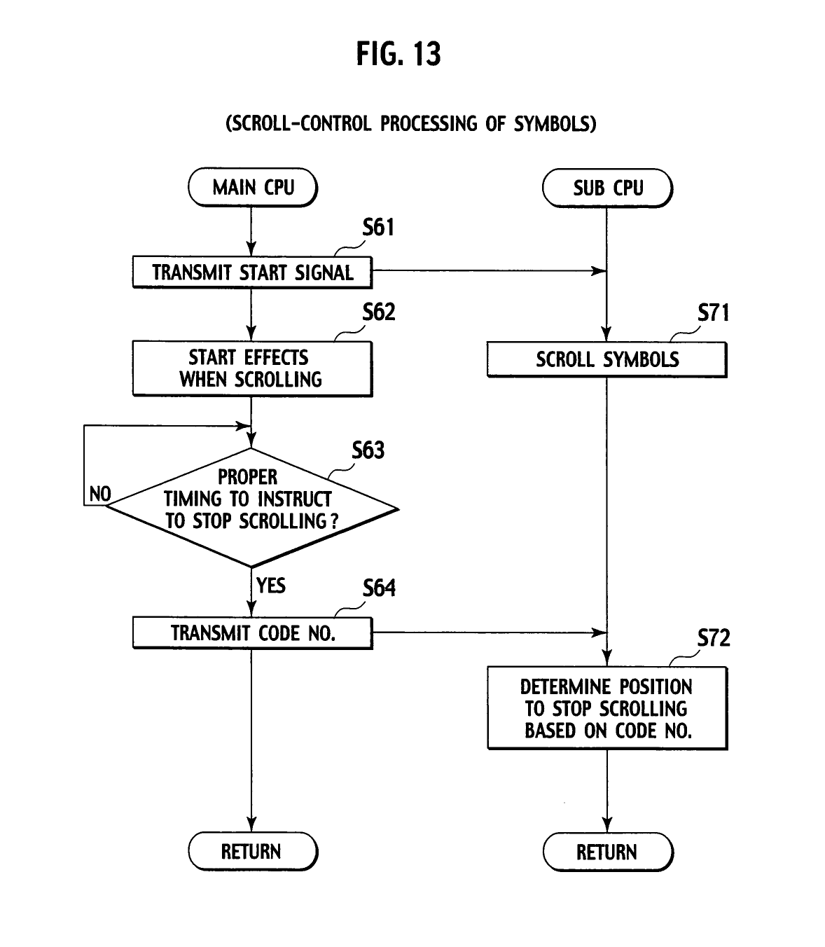

FIG. 13 is a flow chart illustrating the symbol scroll control processing shown in step S15 of FIG. 8. Here, the processing is one that is executed between the main CPU 41 and the sub CPU 61.

First, the main CPU 41 transmits, to the sub CPU 61, a start signal that starts scrolling of symbols on the display areas 28 of the liquid crystal display unit 17 (step S61). Upon receiving the start signal from the main CPU 41, the sub CPU 61 outputs a scroll command of the symbols to the VDP 46. The VDP 46 reads image data of the symbol stored in the image data the ROM 47, and scrolls the symbols on the five columns of the display areas 28 (28a1-28e5) of the liquid crystal display unit 17 (step S71). In this manner, scrolling of the symbols is started on each of the five columns of the display areas 28 (28a1-28e5).

After having transmitted the start signal to the sub CPU 61 in step S61 shown in FIG. 13, the main CPU 41 provides effect at the scrolling of the symbols (step S62). This process is for displaying images to the lower display panel 16 or outputting sound from the speaker 29, for a time period (e.g., three seconds) defined according to the result of the stop-symbol determination processing (step S14 of FIG. 8).

Next, the main CPU 41 determines whether or not it is a proper timing for instructing to stop the scrolling (step S63 of FIG. 13).

If, in the process of step S63, the main CPU 41 determines that it is not a proper timing for instructing to stop the scrolling, the main CPU 41 puts the process back to step S63 and keeps providing effects to the scrolling. Otherwise, if, in the process of step S63, the CPU 41 determines that it is a proper timing for instructing to stop the scrolling, the CPU 41 transmits the code numbers of the symbols stored in the RAM 43 to the sub CPU 61 (step S64). Upon receiving the code numbers of the symbols from the main CPU 41, the sub CPU 61 determines the stopping position of the scrolling in accordance with the code numbers (step S72).

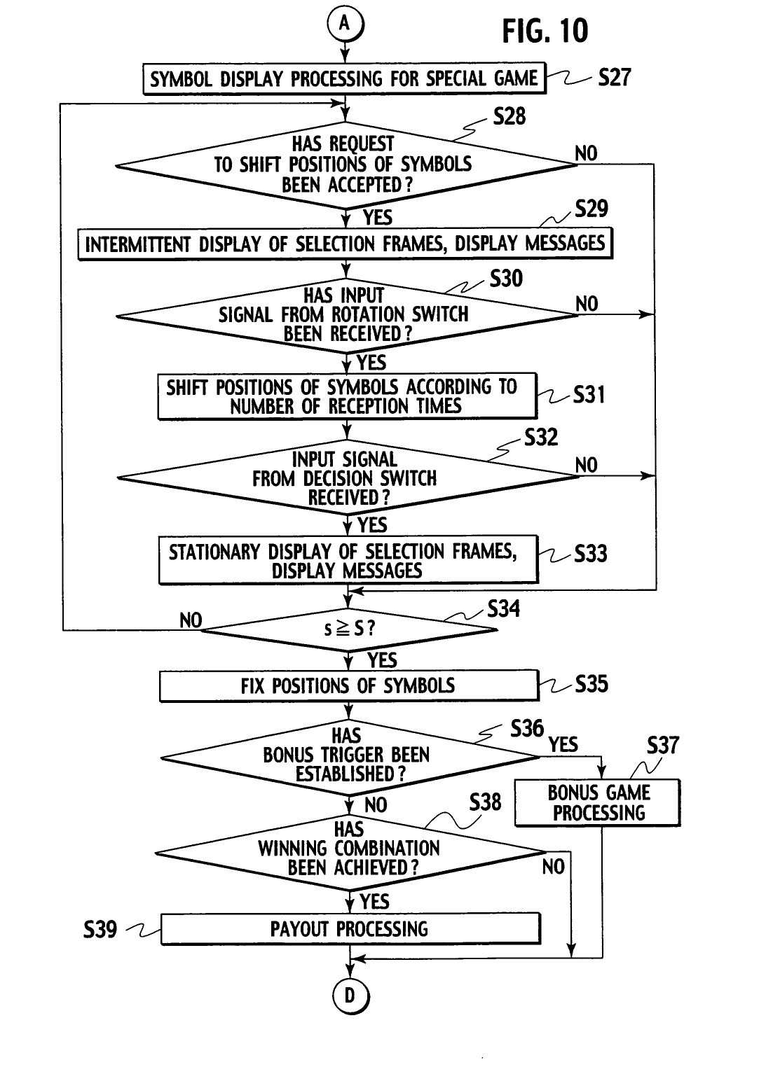

Here, determination of the stopping position by the sub CPU 61 based on the code number transmitted from the main CPU 41, termination of scrolling by the sub CPU 61, and termination of displaying the effect images during the scrolling executed by the main CPU 41, are executed in the base game symbol display processing in step S17 of FIG. 8, or in the special game symbol display processing of step S27 of FIG. 10.

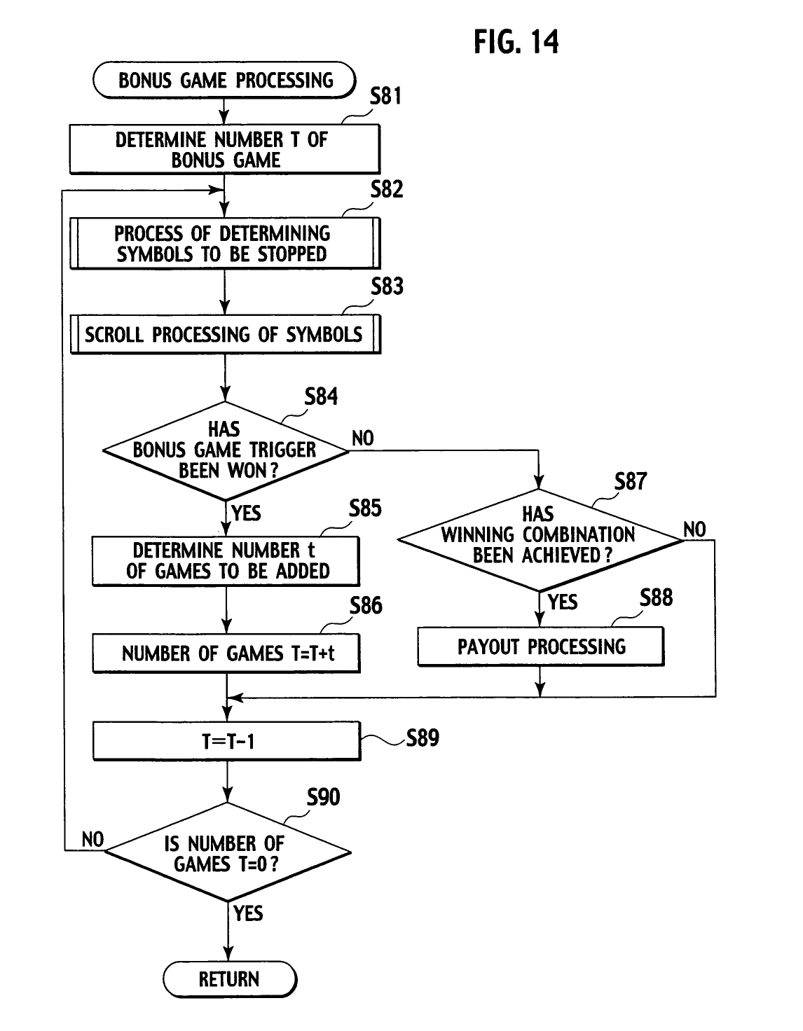

FIG. 14 is a flow chart illustrating the bonus game processing shown in step S19 of FIG. 8, or step S37 of FIG. 10. In the bonus game processing, the main CPU 41 first sets the number of execution times T of the bonus game to any number in the range of 10-25 games (step S81), based on the random number value provided by the random number generator included in the stop-symbol determination program stored in the RAM 43. The main CPU 41 stores the determined number of games T in the RAM 43.

Next, the main CPU 41 executes the stop-symbol determination processing (step S82) and the scroll processing of the symbols (step S83). The process of step S82 is generally similar to that described in reference to FIG. 12. Since the process has already been explained, duplicate description will be omitted hereafter.

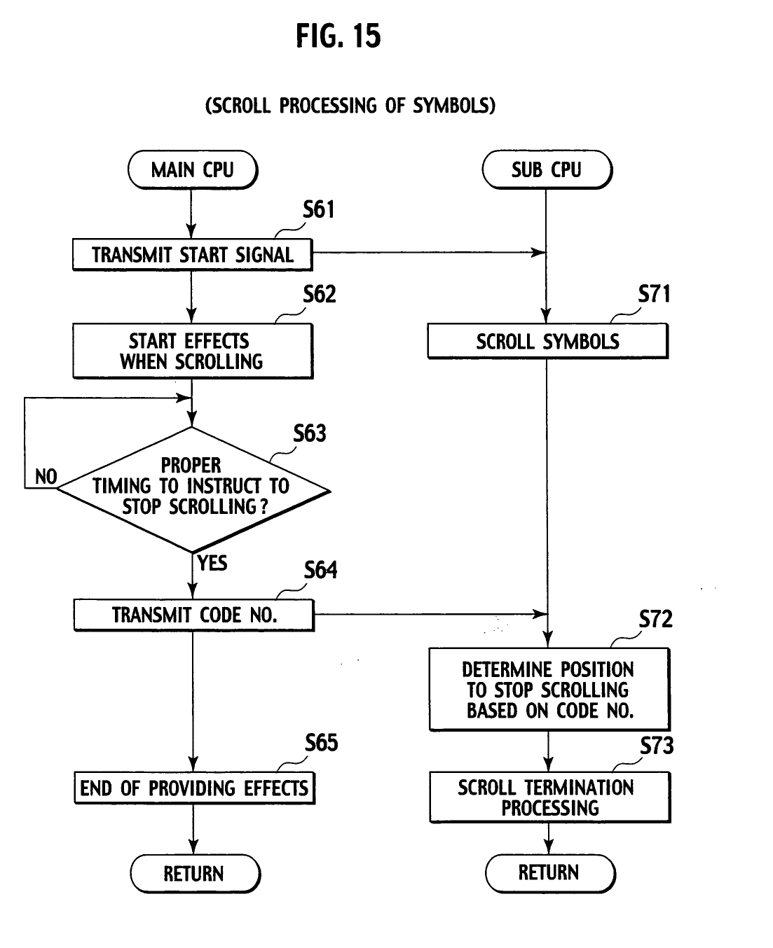

Additionally, in the scroll processing of the symbols in step S83, the processes of step S65 and step S73 are executed, as shown in FIG. 15, in addition to the scroll control processing of the symbols explained using FIG. 13. The sub CPU 61, executes a scroll termination processing, i.e., a process to stop and display the symbols on respective display areas 28 (28a-28e) inside respective display windows 15 (15a-15e) (step S73), after the scroll stopping position determination processing (step S72). In addition, the main CPU 41 terminates the processing of displaying the effect images (step S65) after having transmitted the code numbers of the symbols stored in the RAM 43 to the sub CPU 61 (step S64).

Next, the main CPU 41 determines whether or not the bonus game trigger has been established, i.e., whether or not the combination of “APPLEs” has come to a stop along the activated payline(s) among the paylines La-Le, L1-L5, Lx and Ly (step S84, FIG. 14).

If it is determined that the bonus game trigger has been established (YES in step S84), the main CPU 41 newly determines the number of iterations t of the bonus game (step S85). The determined number of iterations t is added to the number of games T of the current bonus game (step S86). This increases the remaining number of times of the bonus game if the bonus game is won again during the bonus game.

If the bonus game trigger has not been established, the main CPU 41 determines whether or not a winning combination has been achieved (step S87).

Whether or not a winning combination has been achieved is determined by whether or not a combination of “BELLs”, “CHERRYs” or “PLUMs” defined in the payout table of FIG. 4 has been achieved along the activated payline(s) among the paylines La-Le, L1-L5, Lx and Ly.

If it is determined that a winning combination has been achieved (YEN in step S87), the main CPU 41 executes payout of coins according to the number of inserted coins and the combination which has come to a stop (step S88). In this occasion, payout is made based on the payout table shown in FIG. 4.

When the processes of step S86 or S88 are executed, or if it is determined that a winning combination has not been achieved in step S87 (if it is determined to be a loss), the main CPU 41 reads the number of games T of the bonus game stored in the RAM 43 and subtracts “1” from the value T of the read-out number of games. Then, the main CPU 41 stores the number of games T after the subtraction into the RAM 43 again (step S89).

Subsequently, the main CPU 41 determines whether or not the number of execution times of the bonus game has reached a predetermined number (step S90). Specifically, the main CPU 41 determines whether or not the number of games T stored in the RAM 43 has become 0. If the number of games T is not 0, i.e., if it is determined that the number of execution times of the bonus game has not reached a predetermined number, the main CPU 41 puts the process back to step S82 and repeats the above-mentioned process.

On the other hand, if the number of games T is 0, i.e., if it is determined that the number of execution times of the bonus game has reached a predetermined number of times, the main CPU 41 terminates the process. The bonus game is executed in this manner.

As thus described, with the slot machine 10 according to the first embodiment, there is a possibility that, even if the symbols which have been stopped on respective display areas 28a1-28e5 during execution of the special game are not laid out on positions that form a winning combination, the symbols may be newly laid out on positions that form a winning combination by rotating counterclockwise the positions of the symbols which have been stopped on the display areas 28a1, 28a2, 28b1 and 28b2 (or, display areas 28a4, 28a5, 28b4 and 28b5, display areas 28d1, 28d2, 28e1 and 28e2, display areas 28d4, 28d5, 28e4 and 28e5) selected by the player.

Therefore, according to the slot machine 10 of the first embodiment, even if an award has not been won when the symbols are stopped on respective display areas 28a1-28e5, the player's interest in the game can be stirred up in that the player's expectation for an award can be raised by providing the player with an opportunity to achieve a winning combination by shifting the positions of the symbols which have been stopped.

Note that, in the first embodiment, a case is described in which the main CPU 41 shifts the positions of the symbols in the special game upon receiving a request, after all of the symbols on respective display areas 28a1-28e5 are stopped (rearranged). However, the main CPU 41 may also be configured to shift, during the special game, the positions of the already stopped symbols, before some of the symbols are stopped (rearranged), upon receiving a request.

In the following, a slot machine according to a second embodiment of the present invention will be described on the basis of the above characteristic.

The slot machine according to the second embodiment comprises a hardware arrangement essentially similar to the slot machine of the first embodiment. Therefore, the basic constitution relating to the appearance and inside of the slot machine will be described with reference to FIGS. 2, 3 and 5, incorporating the description associated with the numerals and omitting duplicate explanation.

The slot machine 10 according to the second embodiment is different from the slot machine 10 according to the first embodiment, in part with the process which is mainly executed by the main CPU 41.

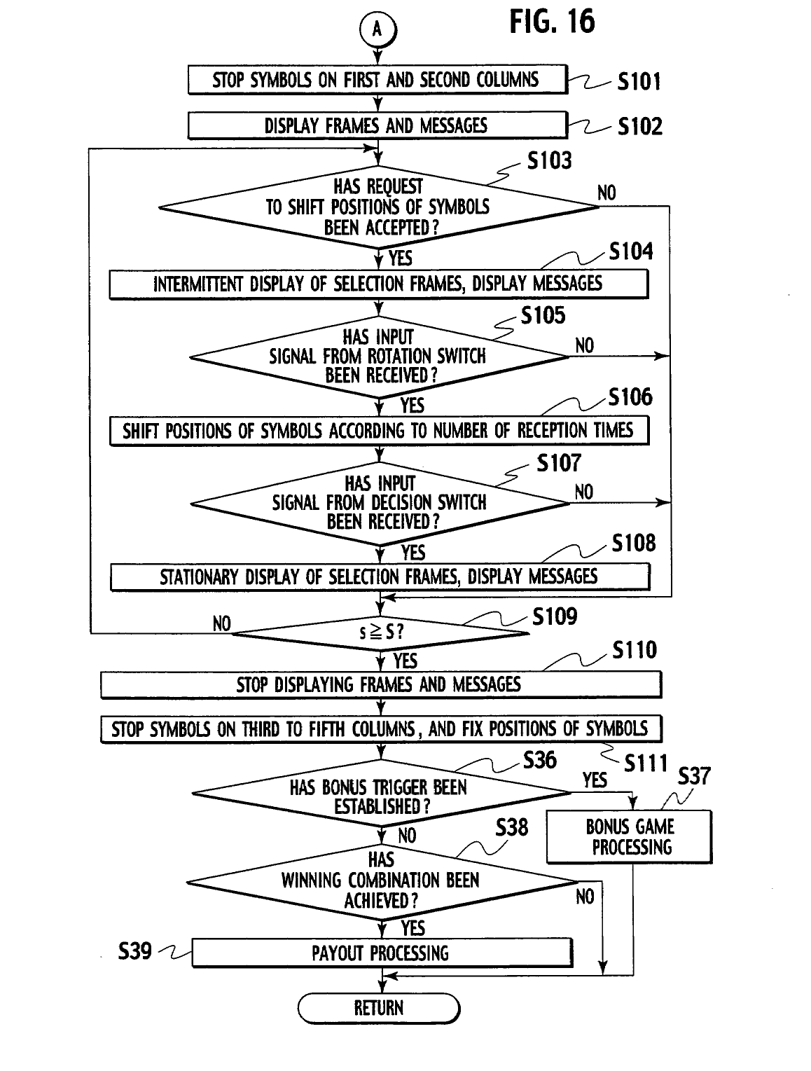

In the following, the processing procedure executed by the CPU 41 of the slot machine 10 of the second embodiment, particularly the part of the processing procedure which is different from the process executed by the main CPU 41 of the slot machine 10 according to the first embodiment will be described with reference to the flow chart of FIG. 16.

FIG. 16 is a flow chart illustrating a part of the processing procedure of the base game executed by the slot machine 10 of the present embodiment.

With the slot machine 10 of the present embodiment, the processes of steps S27-S35 of FIG. 10 are changed to the processes of steps S101-S11 1of FIG. 16, among the base game execution processes (FIGS. 8-11) to be executed by the main CPU 41 of the slot machine 10 of the first embodiment.

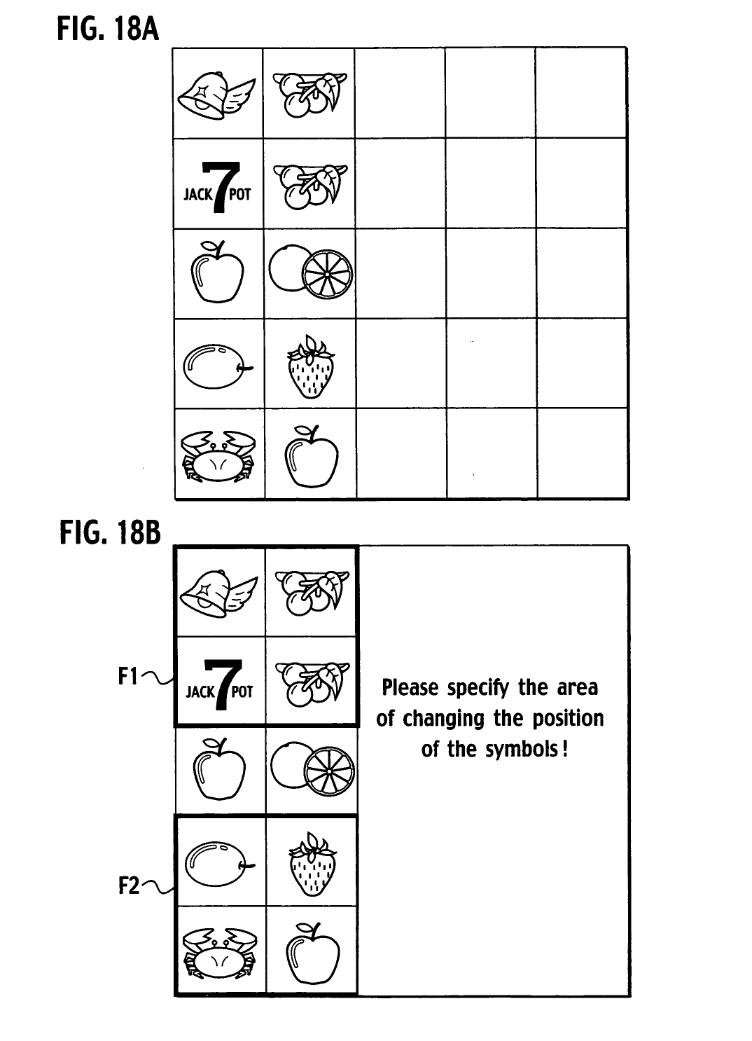

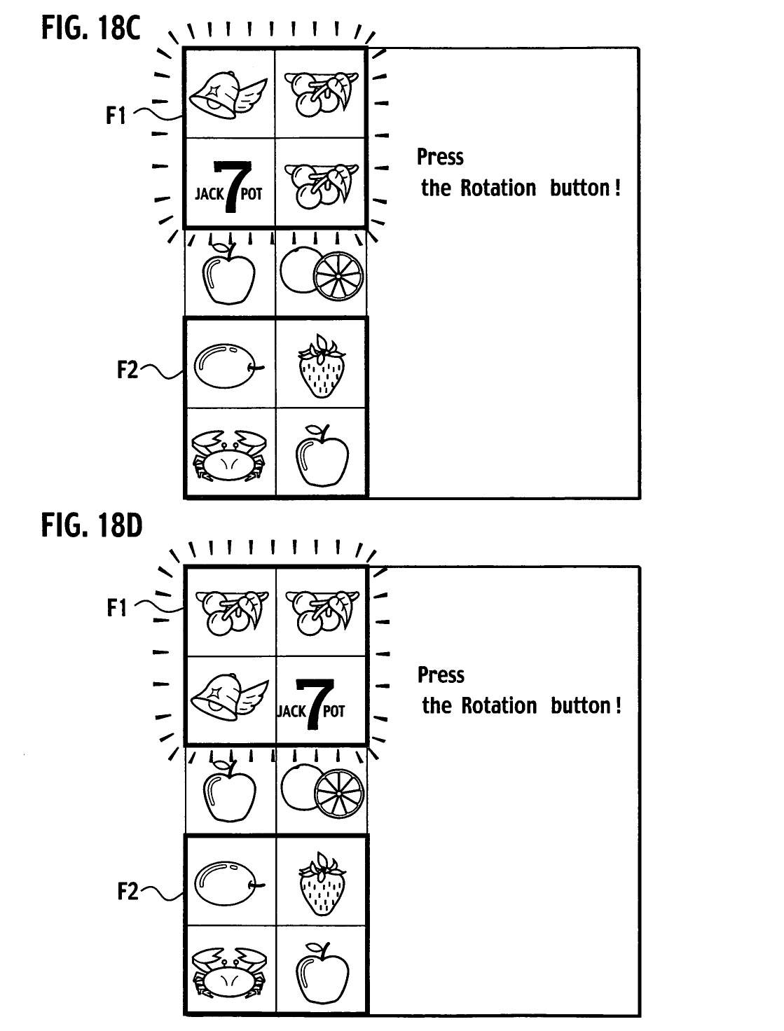

If, in the present embodiment, the flag F of the RAM 43 has turned to “1” in step S 16 of FIG. 8, i.e., if the special game is being executed, the main CPU 41 stops only the symbols on respective display areas 28a1-28b5 of the first and second columns as shown in FIG. 18A (step S101).

In addition, the main CPU 41 displays, on the liquid crystal display unit 17, the frame F1 surrounding the upper four display areas 28a1, 28a2, 28b1 and 28b2 of the first and second columns which have been stopped, and the frame F2 surrounding the symbols on the lower four display areas 28a4, 28a5, 28b4 and 28b5, as shown in FIG. 18B. Furthermore, the main CPU 41 displays, on the display areas 28c1-28e5 of the third to fifth columns of the liquid crystal display unit 17, a message “Please specify the area of changing the position of the symbols!” prompting for possible shifting of the positions of the symbols on each of the frames F1 and F2 (step S102).

Subsequently, the main CPU 41 checks whether or not the four display areas 28a1, 28a2, 28b1, 28b2 surrounded by the frame F1, or the four display areas 28a4, 28a5, 28b4, 28b5 surrounded by the frame F2 have been touched on the touch screen 69 by the player, i.e., whether or not a request to shift the positions of the symbols has been accepted (step S103).

If a request to shift the positions of the symbols has been accepted (YES in step S103), the main CPU 41 switches the display mode, on the liquid crystal display unit 17, of the frame F1 surrounding the display areas 28a1, 28a2, 28b1 and 28b2 (or the frame F2) selected by the player's touching operation to an intermittent display as shown in FIG. 18C (step S104). In addition, the main CPU 41 displays a message “Press the Rotation button!” on respective display areas 28c1-28e5 of the third to fifth columns of the liquid crystal display unit 17, promoting the player to operate the rotation button 82 (step S104).

In the following discussion, it is assumed that the upper four display areas 28a1, 28a2, 28b1 and 28b2 of the first and second columns have been selected by the player as the display areas for shifting the positions of the symbols.

The main CPU 41 then determines whether or not an input signal accompanying the player's operation of the rotation button 82 has been received from the rotation switch 82S (step S105).

If the main CPU 41 has received an input signal from the rotation switch 82S (YES in step S105), it rotates counterclockwise the positions of respective symbols which are stopped on the display areas 28a1, 28a2, 28b1 and 28b2 selected by the player, according to the number of times the input signal has been received, as shown in FIG. 18D (step S106). In addition, the main CPU 41 determines whether or not an input signal accompanying the player's operation of the decision button 83 has been received from the decision switch 83S (step S107).

If the main CPU 41 has received an input signal from the decision switch 83S (YES in step S107), it switches the intermittent display of the frame F1 surrounding the display areas 28a1, 28a2, 28b1 and 28b2 back to the stationary display mode. In addition, the main CPU 41 displays a message “Please specify the area of changing the position of the symbols!” on respective display areas 28c1-28e5 of the third to fifth columns of the liquid crystal display unit 17 again, prompting for possible shifting of the positions of the symbols within respective frames F1 and F2 (step S108).

Additionally, if the main CPU 41 has not accepted a request to shift the positions of the symbols (NO in step S103), has not received an input signal from the rotation switch 82S (NO in step S105), or has not received an input signal from the decision switch 83S (NO in step S107), it checks whether or not the elapsed time s since the symbols came to a stop on respective display areas 28a1-28e5 has reached a predetermined acceptance period S (step S109). The main CPU 41 still checks whether or not the elapsed time s has reached the acceptance period S (step S109), after switching the intermittent display mode of the frame F1 back to the stationary display mode and displaying the message “Please specify the area of changing the position of the symbols!” on respective display areas 28c1-28e5 of the third to fifth columns of the liquid crystal display unit 17 again (step S108). If the elapsed time s has not reached the acceptance period S (NO in step S109), the main CPU 41 repeats the process of step S103 and subsequent steps.

On the other hand, if the elapsed time s has reached the acceptance period S (YES in step S109), the main CPU 41 stops displaying the frames F1 and F4, and stops displaying messages on respective display areas 28c1-28e5 of the third to fifth columns of the liquid crystal display unit 17 (step S110). Subsequently, the main CPU 41 stops the symbols on respective display areas 28c1-28e5 of the third and fifth columns and fixes the positions of the symbols on respective display areas 28a1-28e5 (step S111).

After having fixed the positions of the symbols on respective display areas 28a1-28e5 in step S111, the main CPU 41 executes the processes after step S36 to determine whether or not the bonus trigger has been established by the symbols on respective display areas 28a1-28e5.

The base game and special game are executed in this manner.

Therefore, also with the slot machine 10 of the present embodiment, as with the slot machine 10 of the first embodiment, the special game is executed for a predetermined number of times if a predetermined award has been achieved for a predetermined number of times (five in the present embodiment), where the award is such that a winning combination of “CHERRYs” has been achieved along the activated payline(s) among the paylines La-Le, L1-L5, Lx and Ly (payline L1 in FIG. 19B).

There may be a case in which identical symbols can be stopped along the first and second columns of any of the activated payline(s) among the paylines La-Le, L1-L5, Lx and Ly, by shifting, within the frames F1 and F2, the positions of the symbols on the upper four display areas 28a1, 28a2, 28b1 and 28b2 of the first and second columns, or the positions of the symbols of the lower four display areas 28a4, 28a5, 28b4 and 28b5 of the first and second columns when the symbols are stopped on respective display areas 28a1-28b5 of the first and second columns during execution of the special game, even if identical symbols have not come to a stop along any of the activated payline(s) among the paylines La-Le, L1-L5, Lx and Ly.

Therefore, with the slot machine 10 of the present embodiment, the possibility that a winning combination can be achieved along the activated payline(s) among the paylines La-Le, L1-L5, Lx and Ly becomes higher than conventional slot machines, depending on the type of symbols which are stopped on respective display areas 28c1-28e5 of the third to fifth columns.

As thus described, with the slot machine 10 according to the present embodiment, even if the symbols which are stopped on respective display areas 28a1-28b5 of the first and second columns during execution of the special game are not laid out on a position that forms a winning combination, there is a possibility that the symbols may be newly laid out on a position that forms a winning combination by rotating counterclockwise the positions of the symbols which have been stopped on the display areas 28a1, 28a2, 28b1 and 28b2 (or, display areas 28a4, 28a5, 28b4 and 28b5) selected by the player.

Therefore, according to the slot machine 10 of the present embodiment, the player's interest in the game can be stirred up in that, even if there is no possibility to win an award when the symbols are stopped on respective display areas 28a1-28b5 of the first and second columns, the player may expect for an award accompanied by a payout by providing the player with an opportunity to achieve a winning combination by shifting the positions of the symbols which have been stopped.

Although several embodiments of the slot machine according to the present invention have been described as above, they are intended for illustrative purpose only and the present invention is not particularly limited by them. Specific arrangements such as respective units can be changed in design as appropriate. In addition, since the advantages described in the embodiments of the present invention merely enumerate the most preferred advantages provided by the present invention, the advantages of the present invention are not limited to those described in the embodiments of the present invention.

For example, the controller 48 of the present invention may be composed of a CPU such as the main CPU 41 of the motherboard 40 or the CPU 51 of the gaming board 50, which executes the processes according to the program. However, a part of the controller 48 may be composed of a custom IC (Integrated Circuit) such as an ASIC (Application Specific Integrated Circuit), or a DSP (Digital Signal Processor), for example.

Additionally, with the slot machine 10 of the second embodiment, the symbols whose positions can be shifted by the player are the upper four symbols surrounded by the frame F1 of the first and second columns, which have been stopped precedingly, or the lower four symbols surrounded by the frame F2.

However, for example, the symbols on the fourth and fifth columns may be stopped precedingly together with the symbols on the first and second columns, among which the positions of the symbols on the upper four display areas 28d1, 28d2, 28e1 and 28e2, and the symbols on the lower four display areas 28d4, 28d5, 28e4 and 28e5 may by shifted by the player.

In other words, display areas on which symbols have been stopped precedingly, with their positions being shiftable by the player's request, can be arbitrarily selected column-wise, such as the display areas 28a1-28a5 of the first column, for example. Alternatively, display areas can be selected row-wise instead of column-wise, or can be selected for individual display areas 28a1-28e5 instead of row-wise or column-wise.

Also, the movement of symbols is not limited to counterclockwise, as with the first and second embodiments, or clockwise rotation. For example, the symbols may be moved to the display areas 28a1-28e5 along the diagonal line across the frames F1 to F4 (or display areas 28a1-28b5 along the diagonal line across the frames F1 and F2), and the destination of the movement of the symbols may be provided at random without depending on a specific pattern.

In that case, the rotation button 82 is used to indicate the symbols and destination of their movement.

Furthermore, with the slot machine 10 of the first embodiment, the period during which the main CPU 41 accepts, from the rotation switch 82S or the decision switch 83S, input signals accompanying the player's operation of the rotation button 82 or the decision button 83 is assumed to be the period from when the symbols came to a stop on respective display areas 28a1-28e5 to when the acceptance period S is passed.

In addition, with the slot machine 10 of the second embodiment, the period during which the main CPU 41 accepts, from the rotation switch 82S or the decision switch 83S, input signals accompanying the player's operation of the rotation button 82 or the decision button 83 is assumed to be the period from when the symbols came to a stop on respective display areas 28a1-28b5 of the first and second columns to when the acceptance period S is passed.

However, it is optional whether or not to limit the acceptance period of input signals from the rotation switch 82S or the decision switch 83S in terms of time.

Then, with the slot machine 10 of the first embodiment, if the acceptance period is not limited in terms of time, the main CPU 41 fixes the positions of the symbols which are stopped on respective display areas 28a1-28e5 by accepting input signals accompanying the player's operation of the decision button 83 from the decision switch 83S, for example.

In addition, with the slot machine 10 of the second embodiment, if the acceptance period is not limited in terms of time, the main CPU 41 fixes the positions of the symbols, which have been stopped precedingly on respective display areas 28a1-28b5 of the first and second columns, by accepting input signals accompanying the player's operation of the decision button 83 from the decision switch 83S, for example, and the main CPU 41 subsequently stops the symbols on respective display areas 28c1-28e5 of the remaining third and fifth columns.

What is claimed is:

1. A slot machine comprising:
a display on which a plurality of symbols that have been arranged are rearranged in a unit game; and
a controller operable to:
(a) execute a predetermined number of times of the following unit game as a special game, whenever the number of times of occurrence of a predetermined award accompanied by payout of credits during the unit games reaches a predetermined number of times; and
(b) during the special game, accept an external input requesting to shift the positions of the symbols which have already been rearranged on the display and shift the positions of at least two or more symbols among those which have already been rearranged.

2. The slot machine according to claim 1,
wherein, during the special game, the controller is operable to accept the external input before rearranging some of the symbols and shift the positions of the symbols which have already been rearranged before rearranging the some of the symbols.

3. The slot machine according to claim 1,
wherein, during the special game, the controller is operable to reject acceptance of the external input after a predetermined time period elapsed since the rearrangement of the symbols which have already been rearranged.

4. A slot machine comprising:
a display on which a plurality of symbols that have been arranged are rearranged in a unit game; and
a controller operable to:
(a) execute a predetermined number of times of the following unit game as a special game, whenever the number of times of occurrence of a predetermined award accompanied by payout of credits during the unit games reaches a predetermined number of times; and
(b) during the special game, accept an external input requesting to shift the positions of the symbols which have already been rearranged on the display before rearranging some of the symbols and shift the positions of at least two or more symbols among those which have already been rearranged before rearranging the some of the symbols.

5. The slot machine according to claim 4,
wherein, during the special game, the controller is operable to reject acceptance of the external input after a predetermined time period elapsed since the rearrangement of the symbols which have already been rearranged.

6. A slot machine comprising:
a display on which a plurality of symbols that have been arranged are rearranged in a unit game; and
a controller operable to:
(a) execute a predetermined number of times of the following unit game as a special game, whenever the number of times of occurrence of a predetermined award accompanied by payout of credits during the unit games reaches a predetermined number of times; and
(b) during the special game, accept an external input requesting to shift the positions of the symbols which have already been rearranged on the display before rearranging some of the symbols and until elapse of a predetermined time period since the rearrangement of the symbols which have already been rearranged and shift the positions of at least two or more symbols among those which have already been rearranged before rearranging the some of the symbols; and
(c) reject acceptance of the external input after a predetermined time period elapsed since the rearrangement of the symbols which have already been rearranged.

7. A playing method of a slot machine which executes a unit game for rearranging a plurality of symbols which have been arranged on a display, comprising:
executing a predetermined number of times of the following unit game as a special game, whenever the number of times of occurrence of a predetermined award accompanied by payout of credits during the unit games reaches a predetermined number of times;
accepting an external input requesting to shift the positions of the symbols which have already been rearranged on the display during the special game; and
shifting the positions of at least two or more symbols among those which have already been rearranged.

8. The playing method of the slot machine according to claim 7, further comprising:
accepting the external input before rearranging some of the symbols during the special game; and
shifting the positions of the symbols which have already been rearranged before rearranging the some of the symbols.

9. The playing method of the slot machine according to claim 7, further comprising:
rejecting acceptance of the external input after a predetermined time period elapsed since the rearrangement of the symbols which have already been rearranged during the special game.

10. A playing method of a slot machine which executes a unit game for rearranging a plurality of symbols which have been arranged on a display, comprising:
executing a predetermined number of times of the following unit game as a special game, whenever the number of times of occurrence of a predetermined award accompanied by payout of credits during the unit games reaches a predetermined number of times;
accepting an external input requesting to shift the positions of the symbols which have already been rearranged on the display before rearranging some of the symbols; and
shifting the positions of at least two or more symbols among those which have already been rearranged before rearranging the some of the symbols.

11. The playing method of the slot machine according to claim 10, further comprising:
rejecting acceptance of the external input after a predetermined time period elapsed since the rearrangement of the symbols which have already been rearranged during the special game.

12. A playing method of a slot machine which executes a unit game for rearranging a plurality of symbols which have been arranged on a display, comprising:
executing a predetermined number of times of the following unit game as a special game, whenever the number of times of occurrence of a predetermined award accompanied by payout of credits during the unit games reaches a predetermined number of times;
accepting an external input requesting to shift the positions of the symbols which have already been rearranged on the display before rearranging some of the symbols and until elapse of a predetermined time period since the rearrangement of the symbols which have already been rearranged;
shifting the positions of at least two or more symbols among those which have already been rearranged before rearranging the some of the symbols; and
rejecting acceptance of the external input after a predetermined time period elapsed since the rearrangement of the symbols which have already been rearranged.
